(19) United States
(12) Patent Application Publication
(10) Pub. No.: US 2023/0024233 A1
(43) Pub. Date: Jan. 26, 2023

(54) METHODS RELATING TO PEST CONTROL

(71) Applicant: Globalforce IP Limited, Ponsonby (NZ)

(72) Inventors: Peter Howard, Ponsonby (NZ); Richard Betts, Ponsonby (NZ)

(73) Assignee: Globalforce IP Limited, Ponsonby (NZ)

(21) Appl. No.: 17/788,686

(22) PCT Filed: Dec. 24, 2020
(86) PCT No.: PCT/NZ2020/050180

§ 371 Date: Jun. 23, 2022

(30) Foreign Application Priority Data
Dec. 24, 2019 (NZ) 760552
Dec. 24, 2019 (NZ) 760556

(51) Int. Cl. A01M 23/30; A01M 23/16

(52) U.S. Cl. CPC A01M 23/30; A01M 23/16

(57) ABSTRACT

Disclosed is a method of incapacitating a target pest species. The method having the steps of providing a trap enclosure, the trap enclosure having an entry point for the target pest species into an interior of the trap enclosure, and a bait station to attract the target pest species. Provided also is a kill engine, at least in part mounted from the trap enclosure, to at least in part deliver incapacitating energy to the target species, whereby the kill engine does not require electricity, the kill engine using an inflammable gas charge, the kill engine when triggered actuates and then resets itself. A source of compressed inflammable gas is connected to and supplies the kill engine. Present is a species adapter connected at least in part to the trap enclosure to adapt the trap enclosure to the target pest species, the species adapter based on the size, habits or travel, nature of the target pest species. A kill zone is defined within an interior of the trap enclosure and or the species adapter. A trigger mechanism actuates the kill engine when triggered by the target pest species when in the kill zone. A force delivery hammer, driven by the kill engine, delivers the incapacitating energy, such that when the target pest species enters the apparatus and the kill zone it triggers the trigger mechanism to in turn actuate the kill engine to deliver the incapacitating energy by impacting the pest.

### TECHNICAL FIELD OF THE INVENTION

The present invention relates to pest control.

In particular, though not solely, the present invention is directed to high pressure air or gas powered methods of pest control that are self re-setting.

### BACKGROUND OF THE INVENTION

There is a need to control animal pests and remove them from areas where they are not desired. Such an area may be in nature where they cause harm to the surrounding flora and fauna, or in a factory, commercial or residential situation where their presence is undesirable or dangerous.

Examples of such pests are, but not limited to, rodents such as mice and rats, mustelids such as ferrets, stoats and weasels, marsupials such as possums, or other animals that may be present in an area where they are not desired.

Traps to incapacitate pests loosely fall into the one time trap and those traps that reset themselves.

One time traps are, for example, the typical rat or mouse trap that has a bait platform connected to a restraining bar that in turn restrains a sprung loaded kill bar. Movement of the bait platform due to feeding on the bait by the pest, frees the restraining bar, which in turn allows the sprung loaded kill bar to spring over onto the neck of the pest and break the neck or otherwise incapacitate the pest. Such one time traps, as the name suggests require resetting once they have been actuated, by a user resetting the kill mechanism. Further such one time traps can only act once until they are reset and the carcass removed. Therefore their efficacy is reduced and they cannot trap further pests, even if they are present and enter the trap as the kill mechanism has fired. Further the pest is held by the kill mechanism in the trap and is reliant on the user coming and removing the incapacitated pest manually when they reset the trap. This can lead to decaying of the pest in the trap, which may leave unwelcome or deterrent odours, as well as being distasteful to handle. Further, where there are predators which would prey on such a carcass they are prevented or deterred from naturally removing the carcass.

Other such one-time traps use strong elastic band elements to suffocate the target animal, and result in the dispersal of elastomers (plastics) throughout the environment if the carcass is scavenged after the trap action. These traps require the fitment of a new elastic band for each cycle of operation.

Self resetting traps are, as the name suggests, capable of delivering a kill or incapacitating blow to the target pest, but then will reset themselves so they can become active again and continue to remove pests.

One such example of a self-resetting trap is U.S. Pat. No. 4,349,980 which is directed to a rodent exterminating apparatus which operates by ‘exterminating’ the rodent using a crushing or striking bar, once a trigger has been triggered. The bar operates by pressurised fluid such as air. The rodent is held in position for ˜10 seconds, to ensure the injuries are fatal. The crushing bar is then reset (the 10 second delay occurs by a time delay device). The trigger can be: a bait cup which on light activation will cause the crushing bar to be released; or a thin rod or whisker extending into the pathway which if the rodent attempts to pass will cause the striking bar to be released; or a sensor such as an interruption of an electromagnetic beam such as visible light or a magnetic flux density change sensor or a high frequency acoustic vibration sensor. It is suggested that the trap be arranged vertically to allow easy disposal of the expired rodent. This method at least has the disadvantage that it must hold the rodent for an extended period of time which reduces the cycle rate of the trap. Also, given that a time delay is necessary it is likely that this method of killing by restraining is not humane. This trap is also not stand alone as it requires connection to a centralised source of compressed air.

A further example of a self resetting trap to kill and then remove the rodent is that of U.S. Pat. No. 4,483,094, an admitted improvement over U.S. Pat. No. 4,349,980. This also uses air operation to operate a striking bar to kill the rodent and remain for a period of time, and then retract and reset. Thereafter there is a sweeper that removes the rodent body from the trap and then resets. This has complex air circuitry with numerous built in delays and restrictions to allow for delay of strike, withdrawal and timing of the removal mechanism. This document therefore has a two stage kill and expulsion system resulting in complex circuitry and it requires several built in delays to allow for the kill stroke, then release then expulsion. This trap is also not stand alone as it requires connection to a centralised source of compressed air.

Another such self re-setting trap is that disclosed in New Zealand patent NZ 605708. This uses a supply of compressed carbon dioxide gas in a replaceable cartridge. The trap has a blanked off vertically oriented kill zone which a ground dwelling or travelling, non-vertically curious animal must extend their head up and into, enticed by a bait in the kill zone. In doing so they disturb a fine steel whisker which acts as a trigger to release a portion of the carbon dioxide in a valve train, the final valve allowing a volume of carbon dioxide to drive a piston and in turn a hammer against the pest to incapacitate them. One problem of such traps is they have a waste stream in the form of the spent carbon dioxide canisters. Another is they have low demonstrated efficacy against ground dwelling pests, such as rats and mice that typically do not enter closed spaces, and do not venture upwards into such spaces reducing it's likelihood of being triggered significantly. A further disadvantage of this trap is that it has many different parts and components depending on the target species. There are almost totally different traps for small rodents versus large marsupials, and there is no modularity and little in the way of shared componentry, at least from a user's perspective, even if the internals which are non-user serviceable are shared. There are also reliability issues with de-gassing over time, random triggering when no pest is present, slow reset mechanism resulting in multiple trigger events depleting the source gas, reliant on predation of the carcass for removal from the vicinity. The trap also may exhibit insufficient kill, resulting in inhumane action and inaccurate animal positioning with respect to the kill mechanism at the trigger location, also resulting in inhumane action. There have also been issues with insufficient non-target species exclusion resulting in injured non-target species, in some case including protected species.

It is therefore desirable to have a self-resetting trap that can target multiple target species and go for long periods between maintenance and re-charging, that has high efficacy against a range of pests, is reliable and humane and has a range of common parts between its pest specific forms.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

It is an object of the present invention to provide an improved pest control method to overcome the above shortcomings or address the above desiderata, or to at least provide the public with a useful choice.

### BRIEF DESCRIPTION OF THE INVENTION

In a first aspect the present invention consists in a method of incapacitating a target pest species comprising or including the steps of:
Providing a trap enclosure, the trap enclosure having an entry point for the target pest species into an interior of the trap enclosure, and a bait station to attract the target pest species,
providing a kill engine, at least in part mounted from the trap enclosure, to at least in part deliver incapacitating energy to the target species, whereby the kill engine does not require electricity, the kill engine using an inflammable gas charge, the kill engine when triggered actuates and then resets itself,
providing a source of compressed inflammable gas, connected to, and supplying the kill engine,
having a species adapter connected at least in part to the trap enclosure to adapt the trap enclosure to the target pest species, the species adapter based on the size, habits or travel, nature of the target pest species,
defining a kill zone within an interior of the trap enclosure and or the species adapter,
providing a trigger mechanism to actuate the kill engine when triggered by the target pest species when in the kill zone,
providing a force delivery hammer, driven by the kill engine, to deliver the incapacitating energy,

such that when the target pest species enters the apparatus and the kill zone it triggers the trigger mechanism to in turn actuate the kill engine to deliver the incapacitating energy by impacting the pest.

Preferably the trap enclosure includes, at least in part, an exit aperture from the interior to the exterior, such that the incapacitated target pest species can be ejected from the interior to the exterior.

Preferably includes providing the exit aperture substantially parallel to the translational force, such that the incapacitating energy expels the pest from the trap interior to a trap exterior.

Preferably the translational force alone is sufficient to incapacitate the target pest species.

Preferably the inflammable gas is any one or more of air, carbon dioxide or similar.

Preferably the force released by the trigger is caused by, any one or more of,
a pressure bias acting on an area or multiple areas of the delivery hammer,
the removal of a restraint that stops movement of a compressed elastic member,
a gas spring,
an electromagnetic effect, and
an impact from another moving component on the delivery hammer.

Preferably the impact of the hammer alone is sufficient to incapacitate the target pest species.

Preferably the pest additionally impacts other force delivery portions after impact by the hammer, to delivery sufficient energy to incapacitate the target pest species.

Preferably the trap enclosure or species adapter has the force delivery portion(s), whether static or mobile as a result of the incapacitating energy, that aid in delivering the incapacitating energy.

Preferably the force delivery portion(s) act from the opposing side the force delivery hammer acts from.

Preferably the force delivery portion at least in part obscures the exit aperture.

Preferably the force delivery portion includes a latchable door that co-operates with the force delivery hammer in ejecting the pest from trap and/or delivering the incapacitating energy by initially resisting the force delivery hammer.

Preferably the force delivery hammer delivers a primary incapacitating energy and the force delivery portion co-operates to deliver a secondary incapacitating energy, one or more or both together sufficient to incapacitate the target pest species.

Preferably the latchable door at least in part further obscures the exit aperture.

Preferably the latchable door is on a time or energy delay to increase the energy delivery to the target pest species.

Preferably after the time or energy delay the latchable door opens to expel the target pest species via the exit aperture.

Preferably the latchable door opens in a direction parallel to the motion of the force delivery hammer.

Preferably the latchable door is pivoted on an axis above the kill zone such that when it opens it swings out of the way, the energy imparted to the target pest species then expels it from the kill zone.

Preferably the latchable door uses a magnet, mechanical latch, timing or similar mechanism that is overcome by the energy to then release the door, or that releases the door a certain period of time after triggering of the kill engine, or movement of the force delivery hammer.

Preferably the latchable door is biased to return to the closed latched state by gravity or a biasing mechanism.

Preferably the exit aperture is in a plane substantially perpendicular to the linear action of the force delivery hammer.

Preferably the entry point is in a plane substantially parallel to the linear action of the force delivery hammer.

Preferably the force delivery hammer impacts the target pest species at a first location, and then, after the first location, at a second location, wherein the first location is the skull region and the second location is the body region.

Preferably the force delivery portion is a fixed portion of the trap enclosure which the target pest species will be forced against by the force delivery hammer, to deliver further energy to the target pest species.

Preferably the exit aperture can serve as an entry point for the target pest species.

Preferably the kill engine can be removed from the trap enclosure should it need repair, maintenance or replacement, and the trap enclosure can be left in place.

Preferably the species adapter includes a guide portion to the entry point.

Preferably the guide portion is a guide surface or surfaces for the target pest species, or part thereof, to move along from the mounting surface to the entry point.

Preferably the species adapter at least in part defines the entry point.

Preferably the species adapter at least in part defines the exit aperture.

Preferably the incapacitating energy is sufficient to do to the target pest species any one or more of,
stop the heart,
dislocate the neck and,
disrupt brain matter, or
sever the spinal column,

sufficient to render the pest irreversibly unconscious.

Preferably the target pest species is rendered irreversibly unconscious and expelled within a time frame of under 1 second.

Preferably the target pest species is rendered incapacitated and expelled within a time of 0.050 seconds to 0.2 seconds and preferably within 0.02 seconds.

Preferably the force delivery hammer connects with either the body portion or head portion of the target pest species.

Preferably the force delivery hammer impacts the target pest species at a first location, and then, after the first location, at a second location.

Preferably the first location is the head portion and the second location is the body portion.

Preferably the force delivery hammer is contoured to reduce the area of delivery to the target pest species, to increase the impact stress/energy delivered to effect a humane kill.

Preferably there is a restraining portion to restrain at least in part, the body portion, or head portion, when the force delivery hammer connects with the head portion, or body portion.

Preferably the restraining is dynamic.

Preferably the incapacitating energy, and or gravity is at least in part sufficient to expel the target pest species from the trap interior to the trap exterior.

Preferably the target pest species is expelled from the trap enclosure by the translational force of the force delivery hammer and lifting of a latched door to exit the target pest species.

Preferably the incapacitating energy is sufficient to incapacitate the target pest species upon which the target pest species drops into a body area for retention thereof outside the trap interior.

Preferably the species adapter, or the trap enclosure, provides, via the latchable door, a closable, sealable entry to the carcass retention space to store the carcass of the target pest species once incapacitated.

Preferably the trap is substantially vertically mounted, and entry into and exit out of the trap of the pest is in a vertical direction.

Preferably the pest is a possum or similarly vertically moving pest.

Preferably the trap is substantially horizontally mounted, and entry into, and exit out of the trap is in a horizontal direction.

Preferably the pest is a mouse, rat, stoat, ferret or similar animal.

Preferably the pest control apparatus includes a fluidly connected refillable gas reservoir to hold a store of gas for the gas charge.

Preferably the gas is stored in the refillable reservoir at a pressure between 600 pounds per square inch and 6000 pounds per square inch.

Preferably the gas is regulated to operate the piston at between 125 pounds per square inch and 600 pounds per square inch.

Preferably the gas is stored at 800 pounds per square inch.

Preferably the gas is regulated to operate the piston at 175 pounds per square inch.

Preferably the refillable reservoir remains connected when being refilled.

Preferably a specific target species apparatus can be assembled from the kill engine, trap enclosure and specific target species adapter.

Preferably the trigger mechanism is activated by a body part of the pest, such as the head, body or feet, or may be operated when the pest bites a portion of the trigger mechanism.

Preferably the entry point has a line of sight from the entry, through the trap enclosure, to exterior of the trap enclosure.

Preferably the linear action of the force delivery hammer is substantially perpendicular to the line of sight.

In another aspect the present invention consists in a method of operating a self re-setting trap to incapacitate a target pest species comprising or including the steps of: Luring a target pest species into a trap enclosure, the trap enclosure with a species adapter excluding non-target pest species from entering, the target pest species entering a kill zone defined by the trap enclosure and or species adapter,

The target pest species triggering a trigger mechanism when in the kill zone, which in turn actuates a kill engine, the kill engine, at least in part mounted from the trap enclosure, to at least in part deliver incapacitating energy to the target species, whereby the kill engine does not require electricity, the kill engine using an inflammable gas charge, the kill engine when triggered actuates and then resets itself,
Driving a force delivery hammer across the kill zone to deliver the incapacitating energy,
Expelling the target pest species from the trap by the incapacitating energy and or gravity.

In yet another aspect the present invention consists in a self-resetting pest control apparatus to incapacitate a target pest species and reset itself after such incapacitation, comprising or including,
A kill engine to at least in part deliver incapacitating energy to the target species, whereby the kill engine does not require electricity, the kill engine using an inflammable gas charge, the kill engine when triggered, will actuate and then reset itself,
a source of compressed inflammable gas, connected to and supplying the kill engine,
a force delivery hammer, driven by the kill engine, that when actuated linearly delivers the incapacitating energy to the target pest species by impacting thereon,
A trap enclosure from which the kill engine is at least in part mounted,
the trap enclosure having an entry point for the target pest species into an interior of the trap

enclosure, a bait station, and trigger mechanism to trigger the kill engine, and,
A species adapter to connect at least in part to the trap enclosure to adapt the trap enclosure to the target pest species, the species adapter based on the size, habits or travel

nature of the target pest species,

such that when a target pest species enters the apparatus it triggers the trigger mechanism, causing the kill engine to actuate and deliver incapacitating energy to the target pest species.

Preferably the exit aperture is in a plane substantially perpendicular to the linear action of the force delivery hammer.

Preferably the entry point is in a plane substantially parallel to the linear action of the force delivery hammer.

Preferably the linear action of the force delivery hammer is substantially perpendicular to the line of sight.

Preferably the kill engine drives a piston linearly within a working chamber of the kill engine.

Preferably the piston is connected, directly or indirectly, to a striking rod, which is turn is connected, directly or indirectly to the force delivery hammer.

Preferably the piston is directly connected to the striking rod which in turn is directly connected to the force delivery hammer.

Preferably inwardly from the kill zone is the bait station and trigger mechanism.

Preferably the bait station is accessible from an exterior of the trap enclosure for removal and or checking and refreshing of the bait.

Preferably the bait container is partially permeable and partially or fully transparent in some implementations to facilitate line of sight through the apparatus.

In yet another aspect the present invention consists in a method of operating a trap to incapacitate a target pest species as described herein with reference to any one or more of the accompanying drawings.

In yet another aspect the present invention consists in a pest control trap to incapacitate a target pest species as described herein with reference to any one or more of the accompanying drawings.

In another aspect the present invention consists in a self-resetting pest control apparatus to incapacitate a target pest species and reset itself after such incapacitation, comprising or including,
A kill engine to at least in part deliver incapacitating energy to the target species, whereby the kill engine does not require electricity, the kill engine using an inflammable gas charge, the kill engine when triggered, will actuate and then reset itself,
a source of compressed inflammable gas, connected to and supplying the kill engine,
a force delivery hammer, driven by the kill engine, that when actuated linearly delivers the incapacitating energy to the target pest species by impacting thereon,
A trap enclosure from which the kill engine is at least in part mounted, the trap enclosure having an entry point for the target pest species into an interior of the trap

enclosure, a bait station, and trigger mechanism to trigger the kill engine, and,
A species adapter to connect at least in part to the trap enclosure to adapt the trap enclosure to the target pest species, the species adapter based on the size, habits or travel

nature of the target pest species,

such that when a target pest species enters the apparatus it triggers the trigger mechanism, causing the kill engine to actuate and deliver incapacitating energy to the target pest species.

Preferably the force delivery hammer impacts the target pest species at a first location, and then, after the first location, at a second location.

Preferably the first location is the skull region and the second location is the body region.

Preferably the force delivery hammer is contoured to reduce the area of delivery to the target pest species, to increase the impact stress/energy delivered to effect a humane kill.

Preferably there is a force delivery portion to at least in part co-operate with the force delivery hammer in delivering the incapacitating energy.

Preferably the force delivery portion acts from the opposing side the force delivery hammer acts from.

Preferably the kill engine is triggered by compressed gas via the trigger mechanism triggered by the target pest species.

Preferably the kill engine re-sets itself using a portion of the air charge.

Preferably the portion of the air charge is used after the air charge has done a majority of the work in delivering the incapacitating energy.

Preferably the pest control apparatus includes a fluidly connected refillable gas reservoir to hold a store of gas for the gas charge.

Preferably the gas is stored in the refillable reservoir at a pressure between 600 pounds per square inch and 6000 pounds per square inch.

Preferably the gas is regulated to operate the piston at between 125 pounds per square inch and 600 pounds per square inch.

Preferably the gas is stored at 800 pounds per square inch.

Preferably the gas is regulated to operate the piston at 175 pounds per square inch.

Preferably the refillable reservoir remains connected when being refilled.

Preferably the kill engine drives a piston linearly within a working chamber of the kill engine.

Preferably the piston is connected, directly or indirectly, to a striking rod, which is turn is connected, directly or indirectly to the force delivery hammer.

Preferably the piston is directly connected to the striking rod which in turn is directly connected to the force delivery hammer.

Preferably the piston is connected to the force delivery hammer by a force transmission mechanism.

Preferably the force transmission mechanism can amplify or reduce the force delivered by, or the travel of, the force delivery hammer.

Preferably the path of the force delivery hammer defines a kill zone at least in part within an interior of the trap enclosure.

Preferably inwardly from the kill zone is the bait station and trigger mechanism.

Preferably the bait station is accessible from an exterior of the trap enclosure for removal and or checking and refreshing of the bait.

Preferably the bait container is partially permeable and partially or fully transparent in some implementations to facilitate line of sight through the apparatus.

Preferably the trap enclosure includes, at least in part, an exit aperture from the interior to the exterior, such that the incapacitated target pest species can be ejected from the interior to the exterior.

Preferably the force delivery portion at least in part obscures the exit aperture.

Preferably the force delivery portion includes a latchable door that co-operates with the force delivery hammer in ejecting the pest from trap and/or delivering the incapacitating energy by initially resisting the force delivery hammer.

Preferably the force delivery hammer delivers a primary incapacitating energy and the force delivery portion co-operates to deliver a secondary incapacitating energy, one or more or both together sufficient to incapacitate the target pest species.

Preferably the latchable door at least in part further obscures the exit aperture.

Preferably the latchable door is on a time or energy delay to increase the energy delivery to the target pest species.

Preferably after the time or energy delay the latchable door opens to expel the target pest species via the exit aperture.

Preferably the latchable door opens in a direction parallel to the motion of the force delivery hammer.

Preferably the latchable door is pivoted on an axis above the kill zone such that when it opens it swings out of the way, the energy imparted to the target pest species then expels it from the kill zone.

Preferably latchable door uses a magnet, mechanical latch, timing or similar mechanism that is overcome by the energy to then release the door, or that releases the door a certain period of time after triggering of the kill engine, or movement of the force delivery hammer.

Preferably the latchable door is biased to return to the closed latched state by gravity or a biasing mechanism.

Preferably the exit aperture is in a plane substantially perpendicular to the linear action of the force delivery hammer.

Preferably the entry point is in a plane substantially parallel to the linear action of the force delivery hammer.

Preferably the linear action of the force delivery hammer is substantially perpendicular to the line of sight.

Preferably the force delivery portion is a fixed portion of the trap enclosure which the target pest species will be forced against by the force delivery hammer, to deliver further energy to the target pest species.

Preferably expulsion of the incapacitated target pest species is at least in part aided by gravity.

Preferably the exit aperture can serve as an entry point for the target pest species.

Preferably the species adapter also provides at least in part a mounting portion to mount the pest control apparatus on a mounting surface.

Preferably the mounting surface is a ground or similar surface.

Preferably, the mounting surface is an angled surface which requires a fastening or similar through the mounting portion to the mounting surface.

Preferably the kill engine can be removed from the trap enclosure should it need repair, maintenance or replacement, and the trap enclosure can be left in place.

Preferably the species adapter includes a guide portion to the entry point.

Apparatus as claimed claim 46 wherein the guide portion is a guide surface or surfaces for the target pest species to move along from the mounting surface to the entry point.

Preferably the species adapter at least in part defines the entry point.

Preferably the species adapter at least in part defines the exit aperture.

Preferably the species adapter for predominantly ground dwelling target pest species, such as, but not limited to, rats, mice, rodents, stoats, ferrets, weasels and similar consists of a flat guide surface from the mounting surface to the entry point, and is inclined if the entry point is above the level of the mounting surface.

Preferably for predominantly ground dwelling target pest species the species adapter forms a lower floor for movement along by the target pest species for some or all of the interior of the trap enclosure.

Preferably the species adapter for vertically curious or moving target pest species, such as, but not limited to possums or stoats, includes a guide surface into the entry point, and facilitates the target pest species to reach the trigger mechanism and kill zone.

Preferably the guide surface facilitates grip for the target pest species, or allows the target pest species to grip and move along the mounting surface, for example a tree or log.

Preferably the species adapter is removably connectable to the trap enclosure.

Preferably the force delivery hammer is contoured to amplify the incapacitating energy over certain, or smaller areas.

Preferably the species adapter, or the trap enclosure, provides a closable entry to a carcass retention space to store the carcass of the target pest species once incapacitated.

Preferably the kill engine operates to deliver the incapacitating energy via the force delivery hammer orthogonal to the line of sight.

Preferably a specific target species apparatus can be assembled from the kill engine, trap enclosure and specific target species adapter.

Preferably the trigger mechanism is activated by a body part of the pest, such as the head, body or feet, or may be operated when the pest bites a portion of the trigger mechanism.

Preferably the entry point has a line of sight from the entry, through the trap enclosure, to exterior of the trap enclosure.

In another aspect the present invention consists in a kill engine for a self-resetting pest control apparatus the kill engine can co-operate with a trap enclosure to incapacitate a target pest species and reset itself after such incapacitation, comprising or including,
A trigger receiving mechanism to receive input from a trigger mechanism from the

trap enclosure,
A dose chamber to hold a charge of high pressure air which can be supplied from

a source of compressed air,
A working chamber valved via a dose valve at a proximal end thereof, where in resting state the dose valve prevents the charge from entering the working chamber,
A piston contained within the working chamber and able to translate along the working chamber,
A striking rod, connected to, or from, the piston, to translate there with,

Wherein the trigger receiving mechanism when triggered will rapidly open the dose valve to allow the charge of air to enter the working chamber to a first side of the piston, and drive the piston and striking rod along the working chamber, and wherein the striking rod, or part thereof will extend to then drive a force delivery hammer to the target pest species and deliver incapacitating energy to the target pest species, the dose valve closing to then receive a further charge of air into the dose chamber, and wherein a first biasing on a second side, opposite to the first, of the piston, within the working chamber will act to slow the piston at or towards a distal end of the working chamber, and then return the piston toward the proximal end, and wherein an exhaust valve is opened in communication with the first side to allow the piston to return to a pre-triggered, reset position, the exhaust valve closing, and the trigger receiving mechanism ready to re-trigger the kill engine.

Preferably the first biasing is a spring or air compressed by the second side of the piston within the working chamber.

Preferably the force delivery hammer and striking rod are retracted when the piston returns to the proximal position.

Preferably the source of compressed air is attached and retained to the kill engine.

Preferably the source of compressed air is refillable to enable recharging of the kill engine.

Preferably the kill engine, with the trap enclosure, is light weight and portable.

Preferably the kill engine is at least in part mounted from the trap enclosure.

Preferably the trap enclosure has an entry point for the target pest species into an interior of the trap enclosure, the entry point having a line of sight from the entry, through the trap

enclosure, to exterior of the trap enclosure.

Preferably the bait station entices the target pest species to the interior and into a kill zone of the kill engine.

Preferably the trap enclose houses a bait station, and trigger mechanism to trigger the trigger receiving mechanism.

Preferably there is a species adapter to connect at least in part to the trap enclosure to adapt the trap enclosure to the target species, the species adapter based on the size, habits or travel nature of the target pest species.

In another aspect the present invention consists in a method of incapacitating a target pest species, comprising or including the steps of,

Arming an air powered kill engine from a source of compressed air to at least in part deliver incapacitating energy to the target species, whereby the kill engine does not require electricity, the kill engine can be triggered, then actuate and then reset itself, the

kill engine driving a force delivery hammer, which when actuated will linearly deliver the incapacitating energy to the target pest species,

Providing a trap enclosure from which the kill engine is at least in part mounted, the trap enclosure having an entry point for the target pest species into an interior of the trap enclosure, a bait station, and trigger mechanism to trigger

the kill engine, and,

Providing a species adapter to connect at least in part to the trap enclosure to adapt the trap enclosure to the target species, the species adapter based on the size, habits or travel nature of the target pest species.

Preferably the entry point has a line of sight from the entry, through the trap enclosure, to exterior of the trap enclosure.

In yet another aspect the present invention consists in a method of providing a self-resetting pest control apparatus to incapacitate a target pest species and reset itself after such incapacitation comprising or including the steps of assembling the apparatus from a kill engine, trap enclosure and specific target species adapter to form the species specific self-resetting pest control apparatus.

In yet another aspect the present invention consists in a self-resetting pest control apparatus as described herein with reference to any one or more of the accompanying drawings.

In yet another aspect the present invention consists in a method of incapacitating a target pest species as described herein with reference to any one or more of the accompanying drawings.

In yet another aspect the present invention consists in a method of providing a self-resetting pest control apparatus as described herein with reference to any one or more of the accompanying drawings.

In yet another aspect the present invention consists in a kill engine for a self-resetting pest control apparatus as described herein with reference to any one or more of the accompanying drawings.

As used herein the term “and/or” means “and” or “or”, or both.

As used herein “(5)” following a noun means the plural and/or singular forms of the noun.

The term “comprising” as used in this specification means “consisting at least in part of”. When interpreting statements in this specification which include that term, the features, prefaced by that term in each statement, all need to be present, but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements and features, and where specific integers are mentioned herein which have known equivalents in the art to which this invention relates, such known equivalents are deemed to be incorporated herein as if individually set forth.

Other aspects of the invention may become apparent from the following description which is given by way of example only and with reference to the accompanying drawings.

### BRIEF DESCRIPTION OF THE DRAWINGS

Preferred forms of the present invention will now be described with reference to the accompanying drawings in which;

FIG. 1 shows a flow chart of a preferred embodiment of the invention,

FIG. 2 shows diagrammatically the method of a preferred embodiment of the invention, (the body blow),

FIG. 3 shows diagrammatically the method of another embodiment of the invention, (the dislocation of head & body/spine),

FIG. 4 shows an exploded isometric view of the apparatus used in the method of a preferred embodiment of the invention,

FIG. 5 shows a top view of the apparatus of the preferred embodiment of the invention,

FIG. 6 shows a bottom view of the apparatus of the preferred embodiment of FIG. 4,

FIG. 7 shows a left hand side view of the preferred embodiment of FIG. 4,

FIG. 8 shows a right hand side view of the preferred embodiment of FIG. 4,

FIG. 9 shows a rear view of the preferred embodiment of FIG. 4,

FIG. 10 shows a front view of the preferred embodiment of FIG. 4, showing the entry point from the exterior to the interior, and line of sight through the trap enclosure, the latchable door open,

FIG. 11 shows a front perspective view of FIG. 10,

FIG. 12 shows a further perspective front view of FIG. 10,

FIG. 13 shows a front view of the enclosure with a target pest species entering the trap enclosure, via the species adapter,

FIG. 14 shows a similar view to that of FIG. 13 with the target pest species in the interior, about to trigger the kill engine,

FIG. 15 shows a similar view to that of FIG. 14 with the target pest species caught between the force delivery hammer and the force delivery portion,

FIG. 16 shows a similar view to FIG. 15 where the force delivery portion is a latchable door that after a time or energy delay opens to allow carcass disposal through the exit aperture,

FIG. 17 shows a back view of the preferred embodiment of FIG. 4,

FIG. 18 shows a horizontal sectional view of the preferred embodiment of FIG. 4,

FIG. 19 shows a vertical sectional view of the preferred embodiment of FIG. 4,

FIG. 20 shows a similar view to that of FIG. 15, but where there is no latchable door, and the force delivery portion is a fixed portion, and the target pest species impacts the force delivery portion as part of its expulsion from the trap,

FIG. 21 shows a vertical orientation of the trap, whereby the pest enters the trap; a translational body blow is delivered to the pest; and the pest exits preferably vertically out of the trap enclosure into a carcass management area,

FIG. 22 (A) shows a detail of a variation of the hammer in bottom view, having a head impacting region, and an offset body impacting region,

FIG. 22 (B) shows a detail of the hammer variation in isometric view, having a head impacting region, and an offset body impacting region,

FIG. 23 shows the off-set hammer variation of FIG. 22 in a ready to fire position in a trap, with a pest in the trap that is in position to fire the trap,

FIG. 24 shows the sequence of the trap firing the hammer variation and it extending, the head impacting region impacting the skull of the pest, ahead of the body impacting region in plan view in a trap,

FIG. 25 shows the energy transfer into the pest and it being expelled from the trap,

FIG. 26 shows a side view similar to that of FIG. 4 with the trap connected to a tree or similarly vertically arranged, and the head of a possum or similar pest inside the kill zone activating a bite trigger, and

FIG. 27 shows a left hand side view of the preferred embodiment of FIG. 4, or FIG. 26, configured with a species adapter to target possums, vertically curious or tree or similar dwelling, moving target pest species.

### DETAILED DESCRIPTION OF THE INVENTION

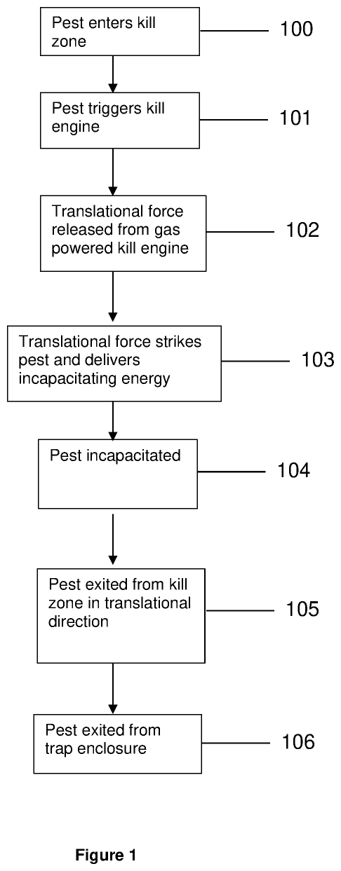

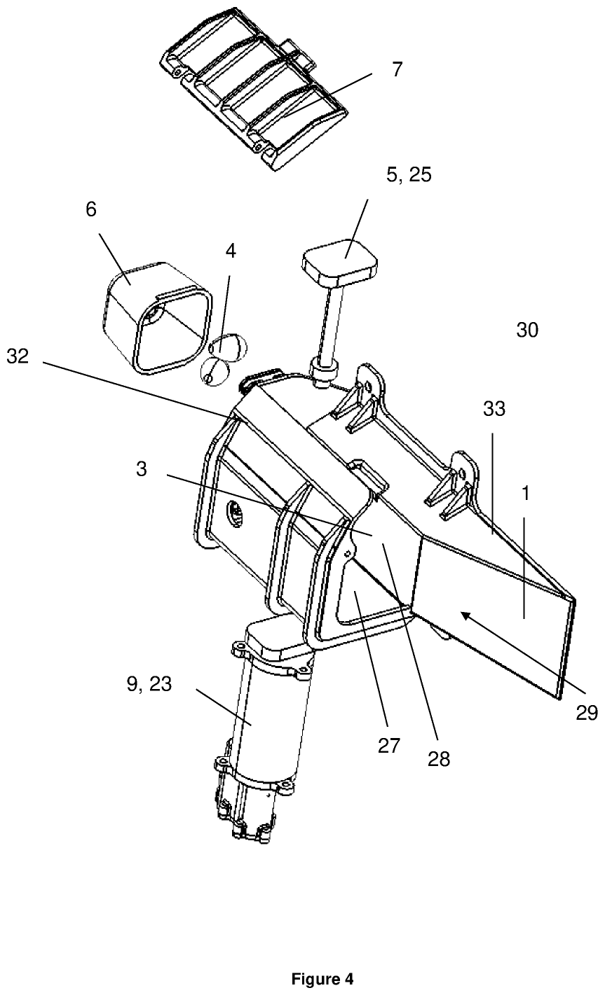

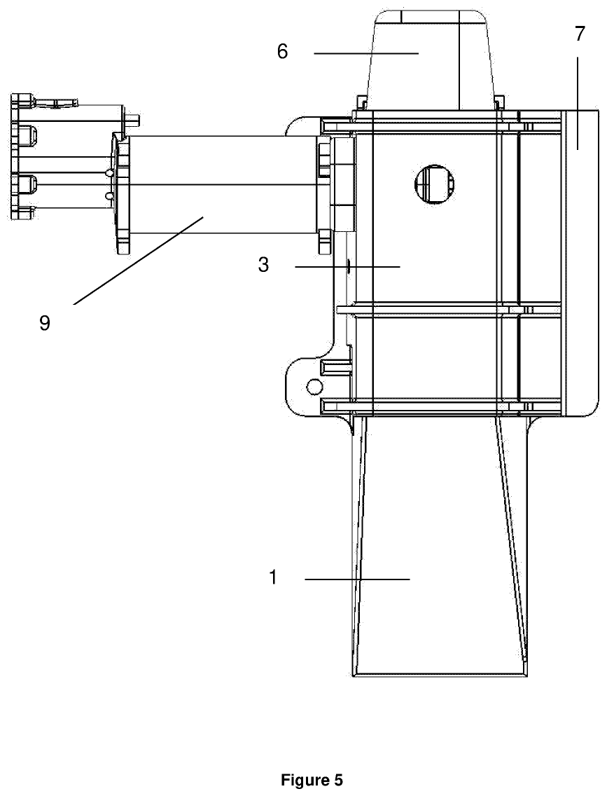

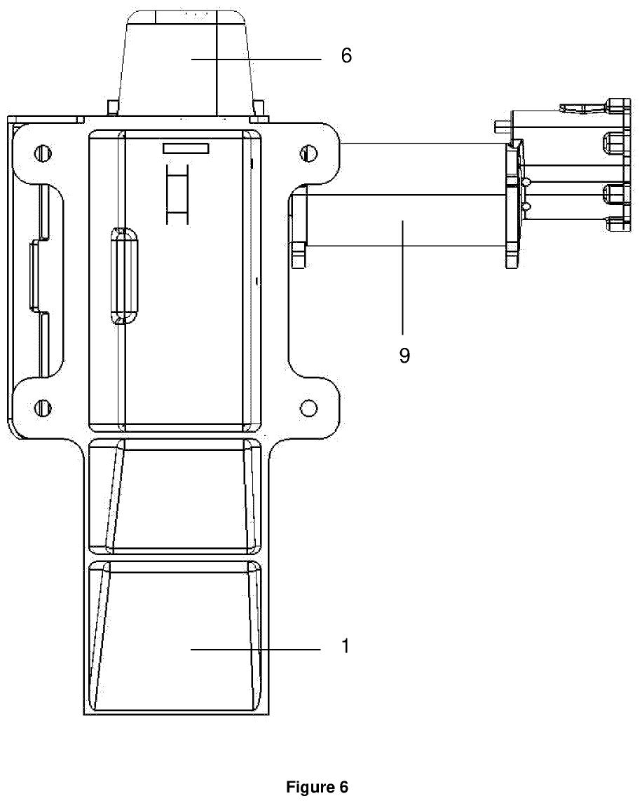

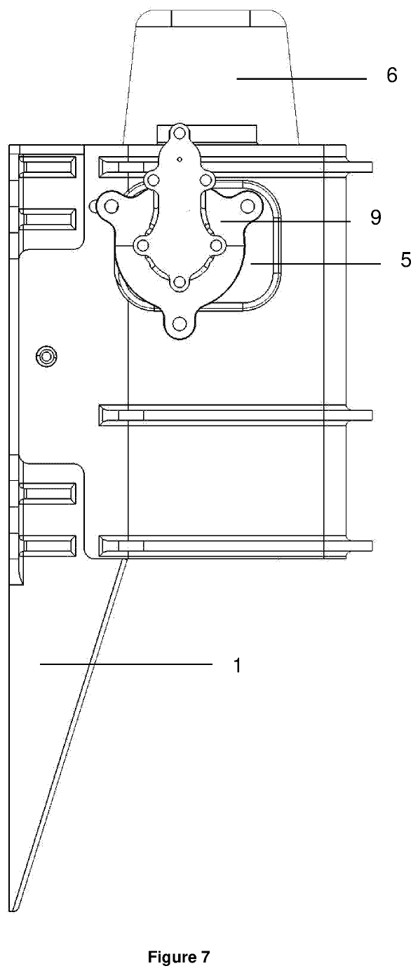

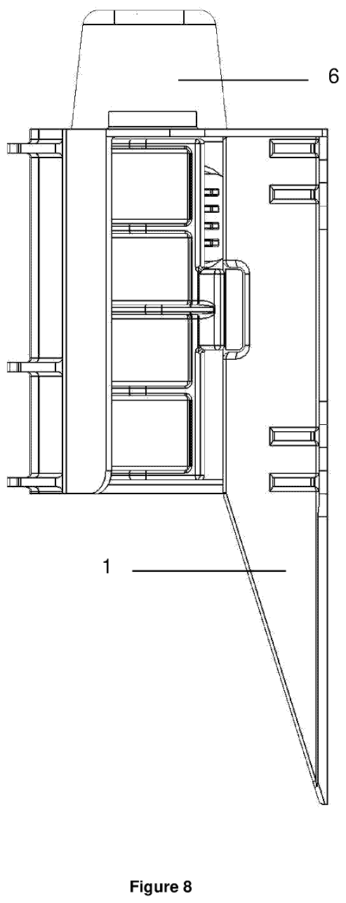

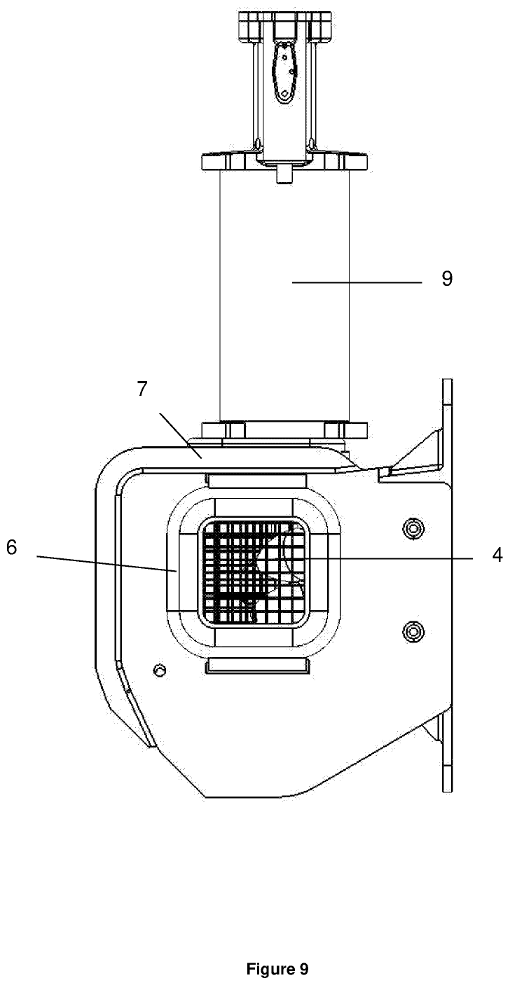

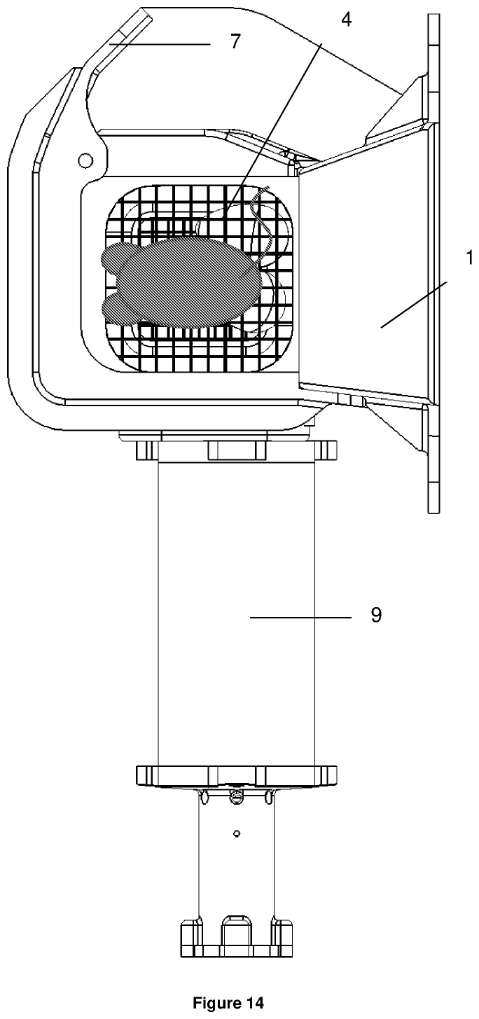

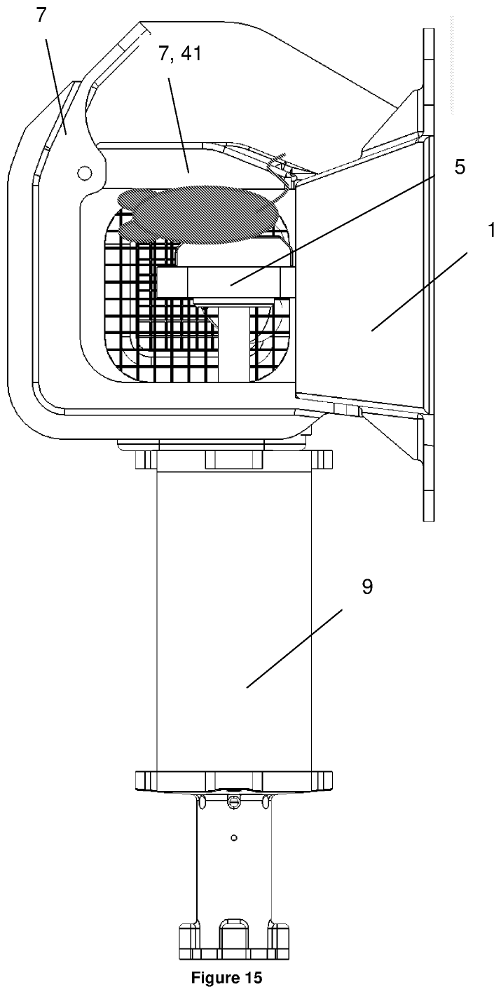

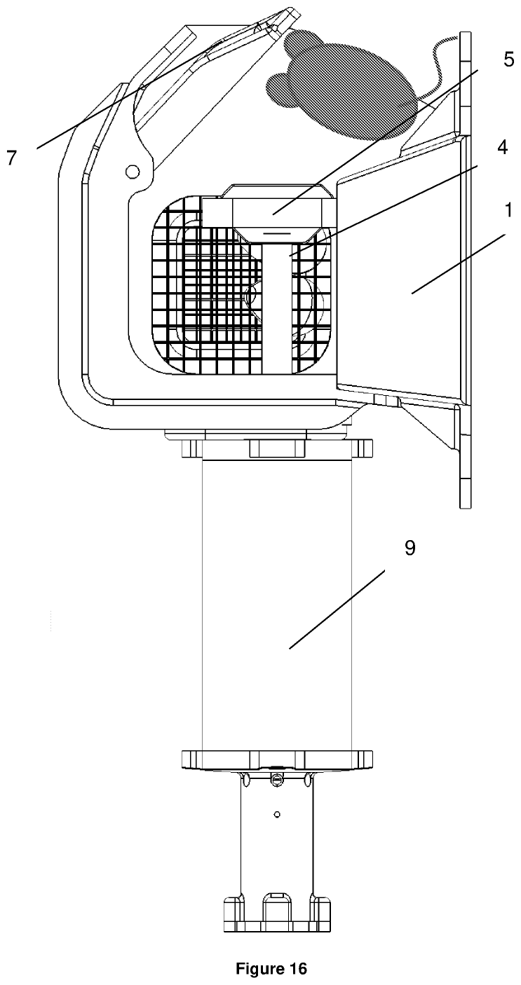

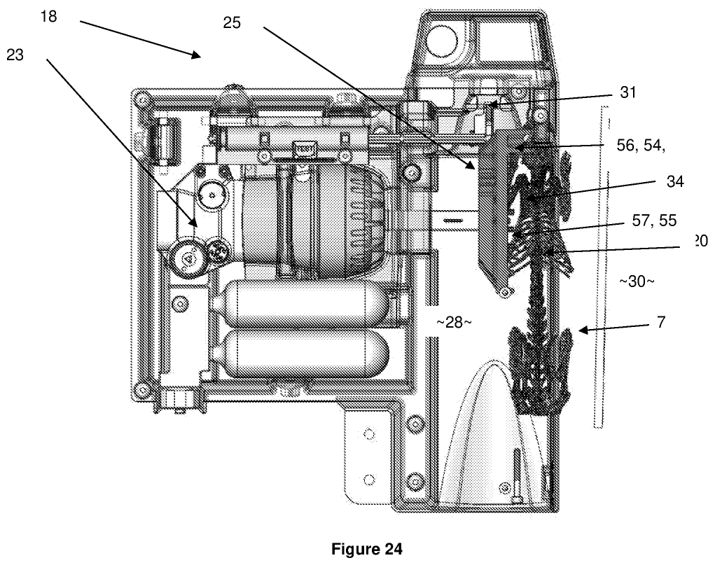

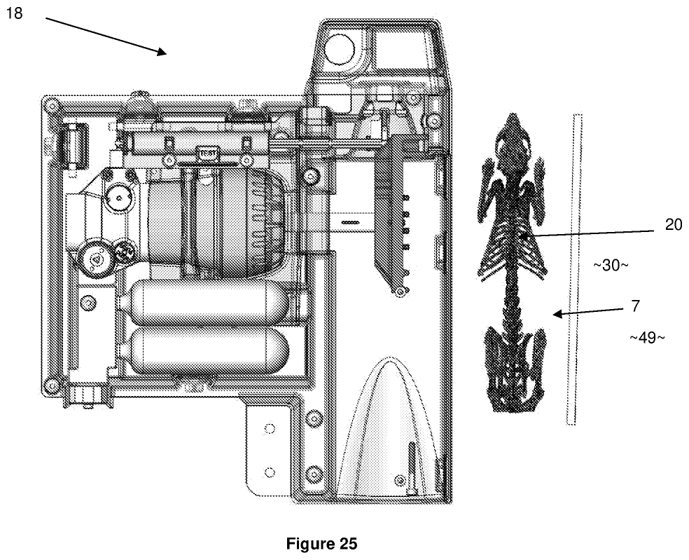

Preferred embodiments will now be described with reference to FIGS. 1 through 26, with the general lay out of the apparatus shown in FIG. 4.

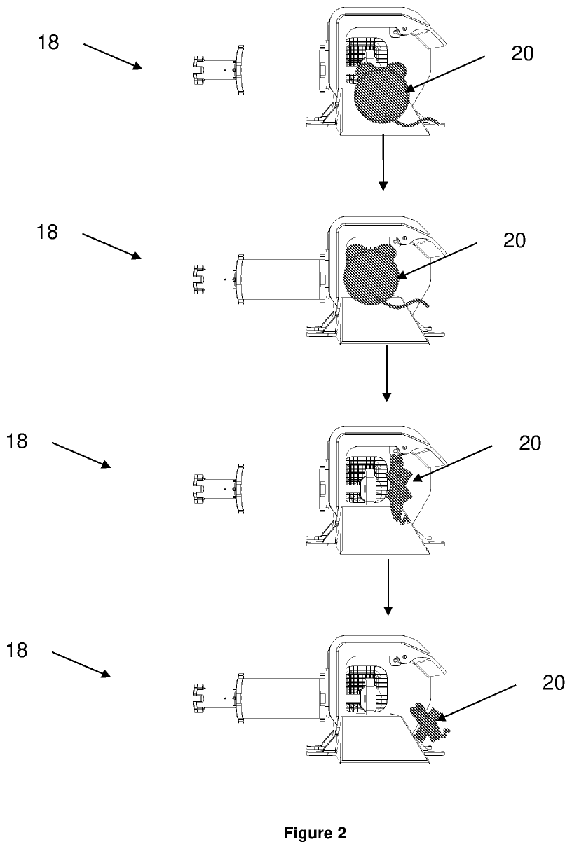

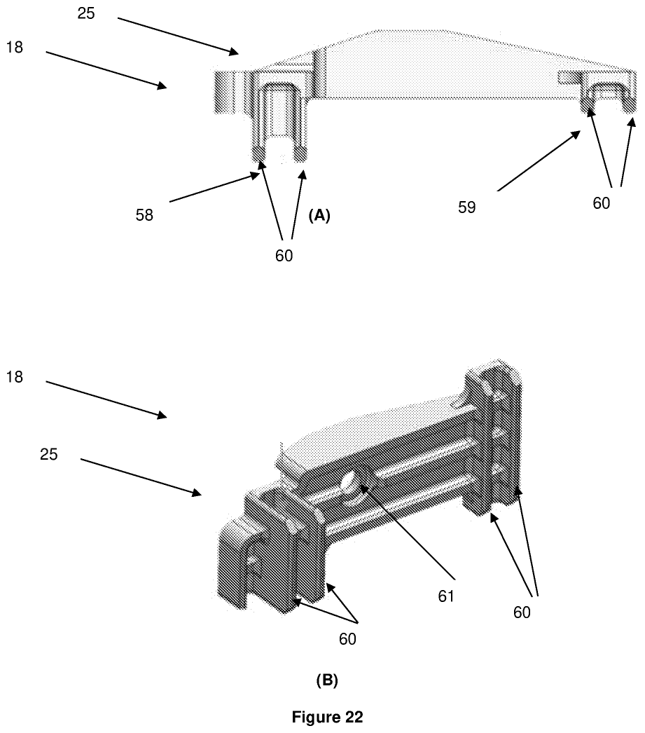

As illustrated in the flow chart of FIG. 1, the first step 100 of the method is the pest entering the trap enclosure 19 and then further entering into the kill zone 34, illustrated in FIG. 2. The second step 101 of the method is the pest triggering the kill engine 21 of the actuation system 9, as shown in FIG. 2. The actuation system 9 is described in further detail below. Once the pest triggers the kill engine 21, a translational force is released from the kill engine 21 in the direction of the pest, shown in FIG. 2 and by third step 102 in FIG. 1. The fourth step 103 of the method occurs when the pest is struck by the translational force from the kill engine 21. An incapacitating force 104 is delivered to the pest 20 via the delivery hammer 25 which is on the end of a striking rod 5 between the kill engine 21 and the hammer 25. This renders the pest irreversibly unconscious. The pest is then expelled from the kill zone 34 by the sheer force of the strike from the delivery hammer 25 in a translational direction preferably the same as the direction of the strike 105. The pest may also fall from the trap under action of gravity, for example in the configuration shown in FIG. 22, when mounted to an upright surface, for example a tree when the pest is a possum or similarly vertically curious pest. Following the strike 105, the pest is entirely exited from the trap enclosure 106 to the trap exterior 30 so as to be disposed of. This may occur by the expired pest being left by the trap exterior 30, for example to be removed by natural predation, or a user, or it may be into body region 57 that may contain the bodies of one or more expired pests. Such body region may use a wastage bag or other form of holding which will be described further below.

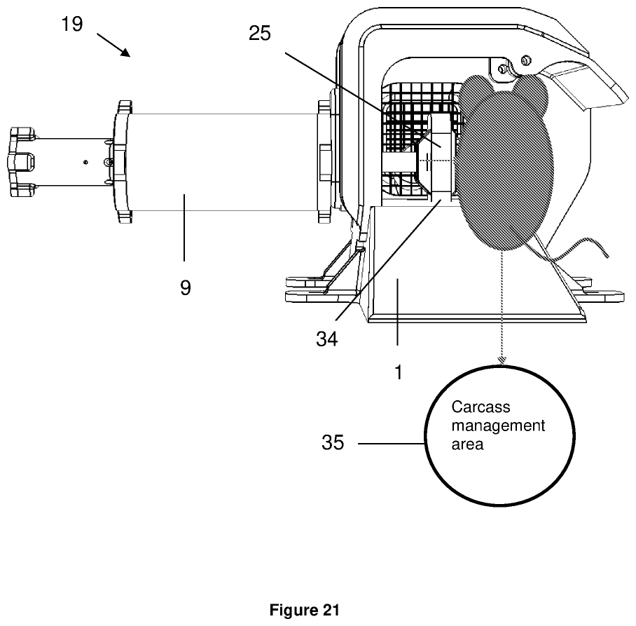

Another preferred embodiment of the present invention is shown in FIG. 21. This embodiment relates to a method of controlling pests via expelling the pests in a direction that is transverse to the direction of the translational force from the kill engine 21. This embodiment involves a strike to the pest in the kill zone 34, and on the pest becoming incapacitated, the pest then drops via its own weight and gravity out of the trap interior 28 to the trap exterior 30. into the body region 35 or 57. This method would be preferable for the vertical mounting, such as on a tree, of the trap enclosure 19, which would be used for example, by possums as the pest.

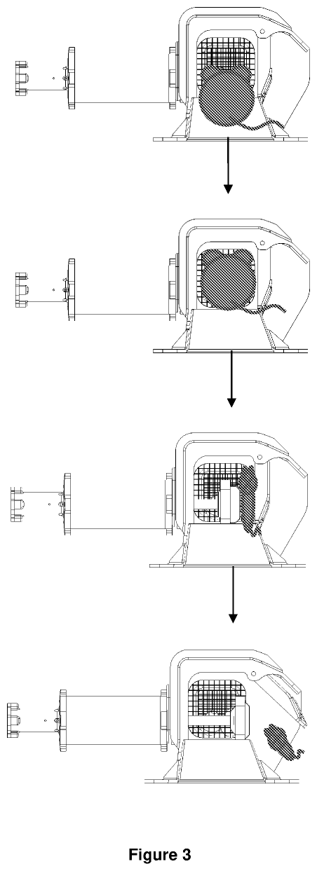

Another preferred embodiment of the present invention is illustrated in FIG. 3. This method involves the translational force from the kill engine 21 via the delivery hammer 25 striking the pest, and the pest striking against the latched door 7, upon which the force causes the latched door 7 to unlatch and expel the pest out of the trap enclosure 19. Preferably in this embodiment, the trap enclosure 19 is horizontally mounted. Preferably, the pest has either the head or the body but not both restrained in a manner such that the incapacitating blow from the delivery hammer 25 via the triggered kill engine 21 will cause the head to be dislocated from the spine, without any physical separation of either part.

In the preferred method the target pest species is incapacitated and killed by the sheer energy delivered to it alone. The force delivery hammer will contact either the head of the body of the target pest species. The energy delivery is over such a short time frame that if delivered to the body, the inertia of the head is such that the body moves to sever the spinal column, and or break the neck. Alternatively if the energy delivery is to the head, then the inertia of the body is such that the body moves to sever the spinal column, and or break the neck. This could be referred to as dynamic restraint of the unimpacted body part. Therefore effectively that part of the target pest species not impacted stays still and results in the spinal column severing and other injuries.

In other forms there may be more of a physical restraint of at least in part, the body portion, or head portion, when the force delivery hammer connects with the head portion, or body portion. This restraint for example may be due to a narrowing of the area the target pest species will put their head into as they reach for the bait. The result again, when the body is impacted is spinal column severing or breaking as well as other high energy injuries that result in near instant and humane incapacitation.

The target pest species is then expelled out of the trap by the translational force alone of the force delivery hammer.

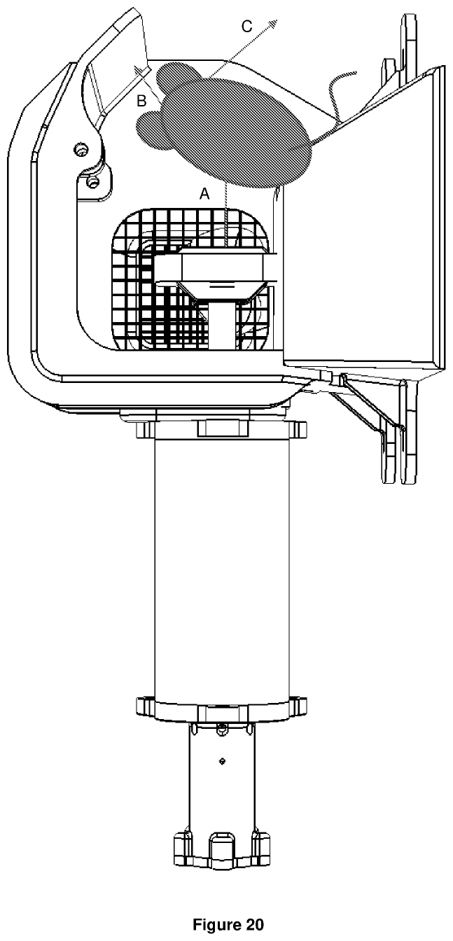

In another preferred embodiment of the present invention, as shown in FIG. 20, the pest triggers the kill engine 21, resulting in the delivery hammer 25 striking the pest (arrow A), after which the pest strikes the upper part of the trap enclosure 19 as shown in FIG. 20 (arrow B), and then due to the force with which the delivery hammer 25 strikes the pest, the pest will be exited out of the trap enclosure 19 (arrow C). Preferably the trap enclosure 19 is horizontally mounted in this embodiment.

FIG. 4 illustrates an exploded view of the trap enclosure apparatus 19, the components of the apparatus are; a ramp 1, a strike zone 3, striking rod 5, latchable door 7 and bait catchment 6. The ramp 1 is either horizontally or vertically aligned depending on the type of pest (ground dwelling such as mice, rats and stouts will have the horizontal plane ramp design whilst tree dwelling such as possums will have the vertical plane ramp design). The ramp 1 is where the rodent or pest enters the trap after it is attracted by the bait.

The bait may be in any form that will attract the pest. In one form, as shown the bait may be of foam eggs preferably the size of a bird egg the target pest species preys on; wherein the foam eggs contain a scent of real (actual) bird eggs.

The bait is contained within a bait catchment or bait station 6, which has a mesh frame on the sides facing the rodent, so that the rodent is able to see through the mesh towards the foam eggs. This provides a line of sight 29 through the apparatus 18 so that the rodent is able to see through the bait mesh towards the foam eggs, and through the other side. This is proven as a more effective way of enticing the target pest species into the interior 28.

The bait station 6 is attached to the trap enclosure 19, or part thereof, or the species adapter 33. As the name suggests this is to lure the pest into the interior 28 and into the kill zone 34. The bait catchment 6 is detachable so as to be removable wherein the bait 4 can be placed within the platform of the strike zone 3, but preferably it is contained within the bait catchment 6.

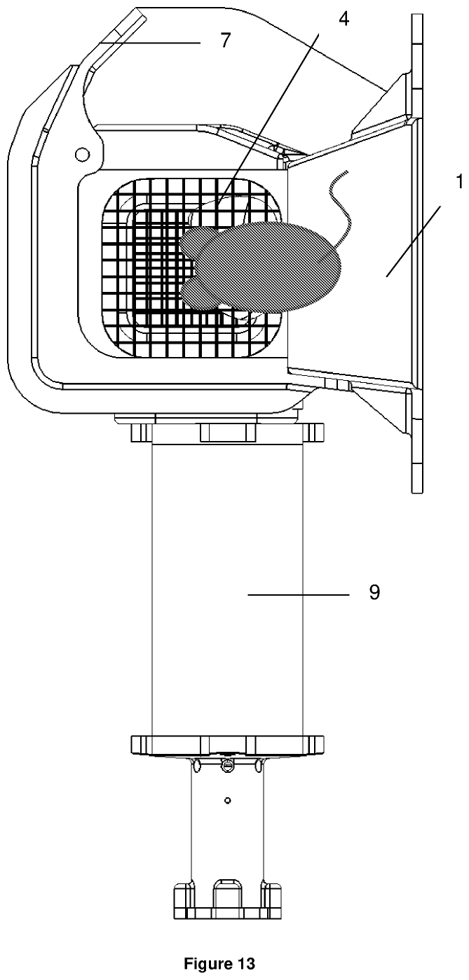

The strike zone is a horizontal flat zone (shown more clearly in FIG. 13) enclosed on both sides where one side consists of the striking rod 5 which will on actuation of a sensor or trigger 31, strike laterally of the target pest species with the force delivery hammer 25. On a side opposing this there is a force delivery portion 32. In the form shown this is a latchable door 7 which is latched or held by some force which can be overcome by the kill engine, eg a magnet, when the pest is in the strike zone 3. Within a certain delay time frame or energy delay the door 7 will open. The remaining energy will then expel the incapacitated pest through the exit aperture 41, which in this case, the opening of the door has exposed. The time delay may be via a latch which becomes unlatched, or the energy delay may be for example, but not limited to a magnet, holding the door closed. When the energy level against the door, from the force delivery hammer 25 striking the pest, and in turn the pest striking the door 7, this retention force of the latch, or magnet is overcome and the door opens.

In a preferred embodiment the force of the striker hammer 25, transmitted through the pest opens the door via action on the animal, i.e. there is no direct action on the door by the striker. Therefore in this arrangement the door is opened after the contact is made between the striker and animal. In an alternative arrangement the striker releases a latch at a certain extension of the striker or delay after a certain extension or triggering.

It should be noted the delay in the door 7 in this case, opening is not to statically dispose of the pest, but rather to act dynamically to apply further incapacitating energy to the pest as well as then expel the incapacitated pest.

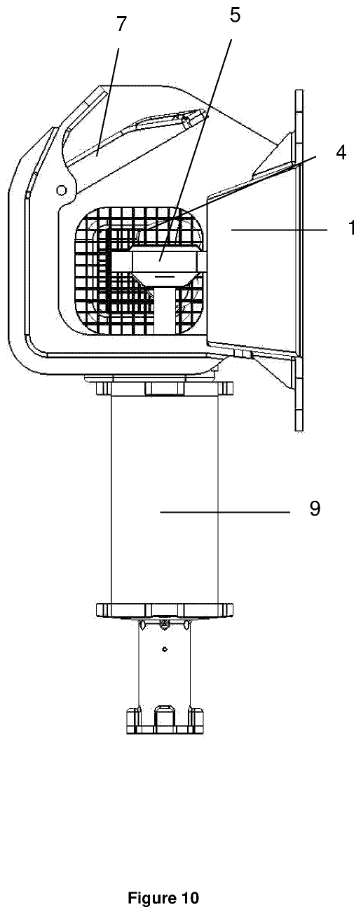

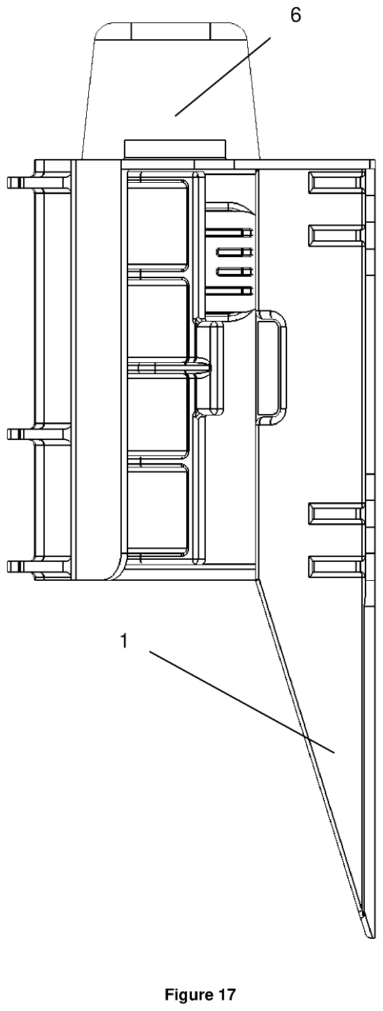

In other forms, shown in FIG. 10, there is no door, but rather part of the trap enclosure or species adapter will further impact the in motion pest as seen in FIG. 17. In this case the force delivery hammer delivers the primary energy, and accelerates the pest, and the force delivery portion 32 delivers secondary energy, decelerating the pest, prior to it being expelled from the exit aperture.

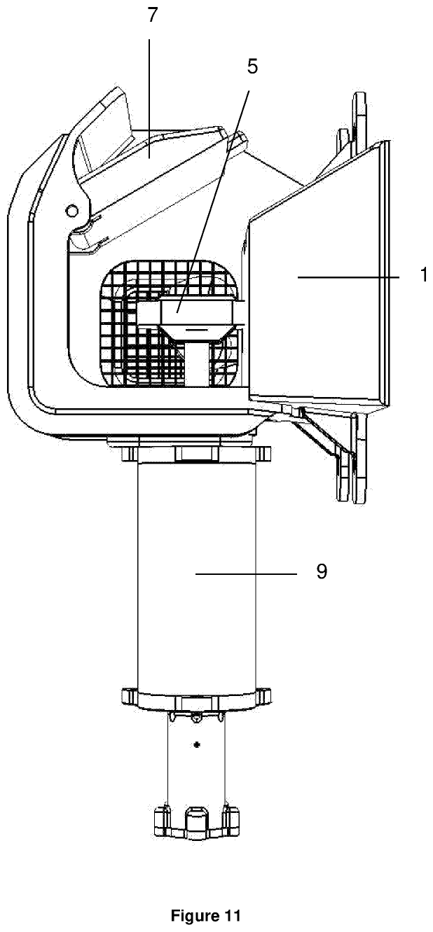

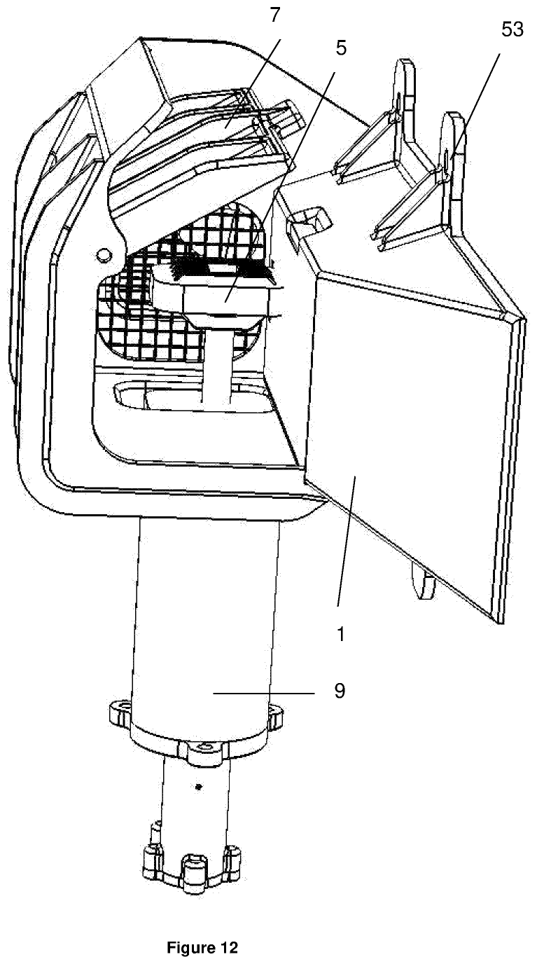

The process of a rodent entering the ramp 1 (FIG. 10), being struck in the strike zone 3 by the striking rod 5 (FIG. 11), and then being exited from the strike zone 3 by the force of the strike so as to unlatch door 7 and exit the now expired rodent from the system (FIG. 12). The process from triggering to expulsion occurs in under 1 second, and in the preferred form occurs within 0.05 seconds to 0.2 seconds, and ideally within 0.1 seconds. This means that from triggering by the pest, to incapacitation is about 0.1 seconds. This short time frame is a very humane way to cull the pest.

With reference to FIG. 21, the exploded view of a preferred form of the invention as a pest control apparatus 18, the components of the apparatus are trap enclosure 19, a species adapter 33, which includes a ramp 1. Within the trap enclosure 19 there is a strike zone 3, and specifically within this a kill zone 34. Within the strike zone 3 is a striking rod 5, and in this embodiment a latchable door 7 and a bait catchment 6.

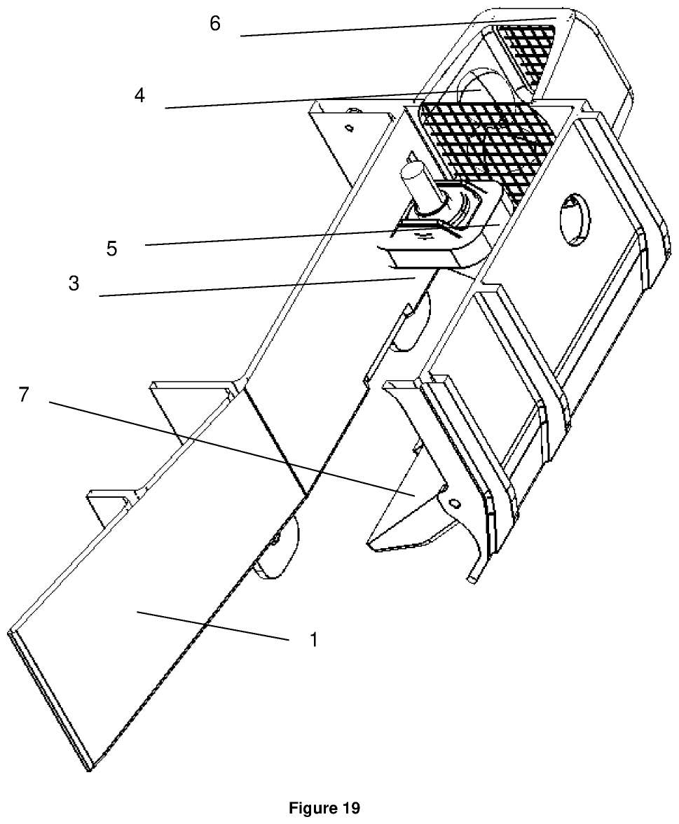

The apparatus 18 or trap, has a species adapter 33, shown at least in FIG. 4, has a guide portion 46, and in particular a guide surface 47. In the embodiment shown the guide surface 47 is a ramp 1 that is open from both sides. In other forms, discussed later in FIGS. 22 to 26 for example, the guide surface 47 may have side portions to further guide the pest in, and may take whatever surface contour, or inclination as necessary to guide the pest in. For example, when the trap enclosure 19, or species adapter 33 place the apparatus 18 closer to the mounting surface 45, then the guide surface 47 may be a very shallow or flat surface such as that shown in FIG. 19. In other variations, such as shown in FIG. 22 for possums and the like target pest species 19, the guide portions 46, may be for a specific part of the target pest species 19 body, for example as shown the head region 56 or a specific part thereof.

Likewise, the apparatus 18 may guide a first location 54 or portion of the body of the pest 19 and impact a second location 55—such as in the further variation shown for rats and like rodent pests 19 in FIGS. 19 through 21. The hammer 25 may also be shaped to deliver sequential impacts to different locations as will be described.

Three variations of hammer 25 are shown in FIGS. 1, 22, and 26 respectively, and these may or may not have corrugations, ribs or similar to multiply, increase or focus the impact energy on the pest 20. They all function to impart energy into the target pest species 20. The hammer 25 of FIG. 1 does so by impacting the pest 20 with energy that renders it irreversibly unconscious in very short time.

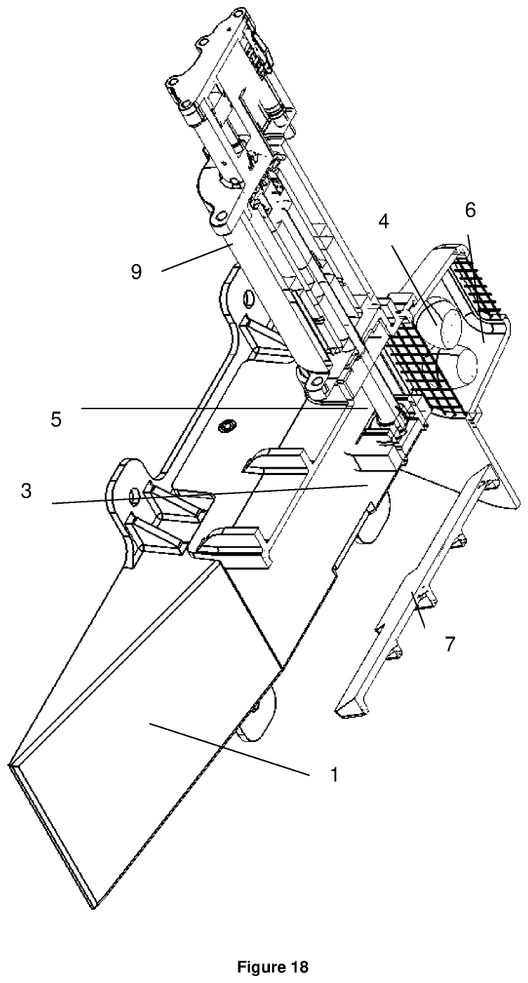

The hammer 25 of FIG. 22 is designed to sequentially impact the pest 20, a connection point 61 to the striking rod 5, for example by using a threaded fastener, is shown. It can be seen the hammer has a first impacting region 58 and a second impacting region 59, there may also be further impacting regions as needed. The first impacting region 58 extends beyond the second impacting region 59 as shown in FIG. 18(A). This is so as the hammer 25 moves toward the pest 20 it impacts a first location 54 of the pest, and then a second location 55. In the example shown in FIG. 20 the first location 54 is the head region 56 and the second location 55 is the body region 57. Impact of the first impacting region 58 to the head 56 is sufficient to render the pest 20 irreversibly unconscious when the pest is a mouse, rat or other rodent. The impact of the second impacting region 59 then propels the carcass of the dispatched pest out of the trap interior 28 to the exterior 30, if a door 7 is present these impacts impart sufficient energy to propel the pest 20 against the door to open it and propel the pest to the exterior 30.

The hammers 25 may have extensions or other contouring 60, on one or more of its impacting surfaces, that act to focus the energy or multiply the force of the impact by targeting a smaller area and increasing the trauma delivered.

In the preferred form the hammer 25 delivers sufficient energy to the pest 20 to disrupt and damage the brain matter of the pest sufficiently to render it irreversibly unconscious.

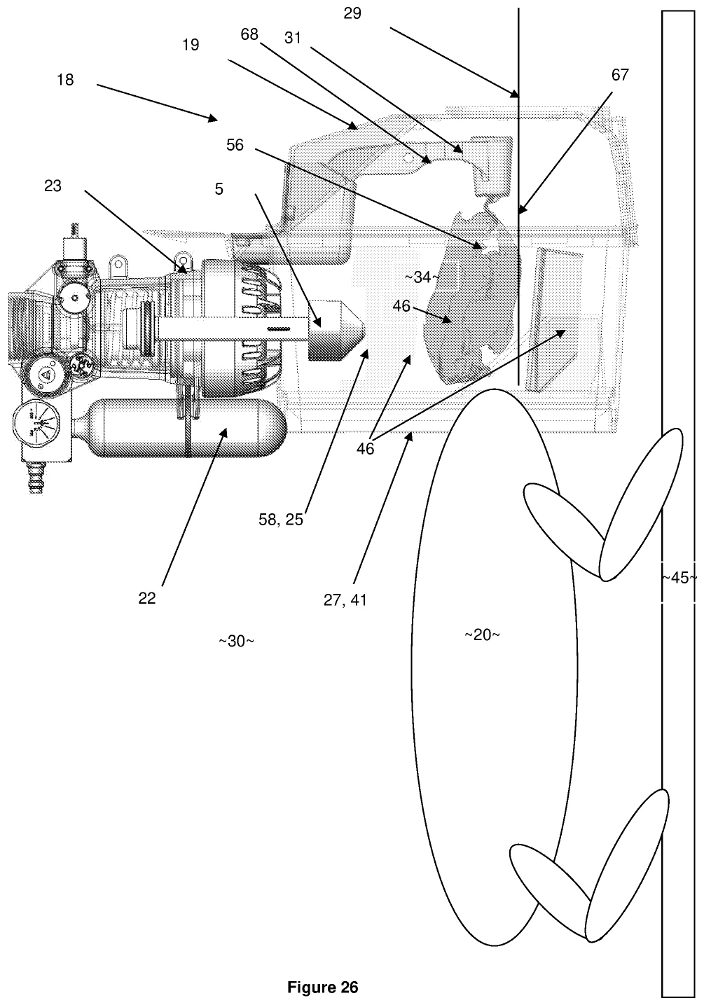

The third variation of hammer is that shown in FIG. 26 and in this case is shown in use against a possum as the pest 20, however this may work on other pests who have a similar anatomy to a possum. In this variation the hammer 25 is a rounded projectile and has a first impacting region 58 only. The hammer 25 in this variation does not come from the side of the trap and across the strike zone 3 and kill zone 34, but rather comes from above, that is above the head of the pest 20 as shown in FIG. 22. The anatomy of a possum requires quite a precise first location 54 strike, which is the head region 56, from above, and into the weakest part of the skull. This impact produces the requisite brain trauma to humanely dispatch the pest 20.

The stroke of the hammer 25 may also be varied if necessary, for example to be penetrative, non-penetrative and to deal with the particular target species. This can be achieved by putting a different kill engine 23 in configured for each desired stroke length, keeping the same kill engine 23 in and reducing the stroke, for example by using a spacer in front of the piston of the kill engine, about the striking rod 5. The spacer could be inside the chamber or may be outside the chamber. The strike zone could also be varied to cater for the target pest and best humane kill by moving it relative to the hammer as needed. This may be done by a series of mounting points of the species adapter or enclosure to move them relative to the kill engine and hammer.

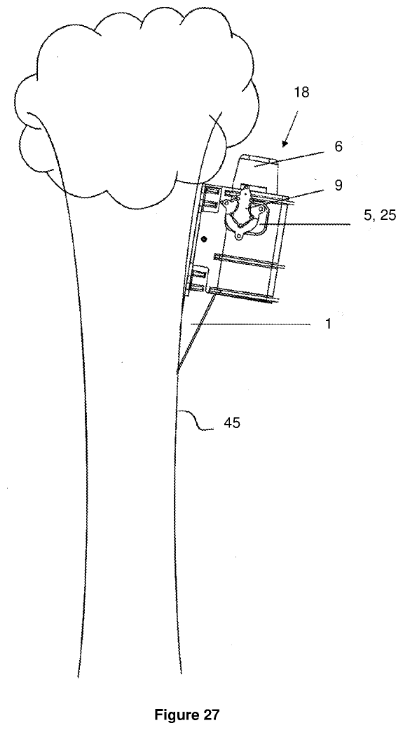

A differing form of species adapter 33 may be used for tree dwelling or vertically curious or mobile pests such as, but not limited to, possums, such as shown in FIGS. 26 and 27. This may have one or more a guide surfaces 47, present for example on one or more guide portions 46 that extend into the strike zone 3, that is/are open to allow the pest to engage on the mount surface, such as the bark of a tree, or similar, or may be otherwise contoured or otherwise provided with grip to allow the pest to continue moving into the trap interior 28. The guide surface(s) 47 and guide portions 46 put the pest 20 in the position for the most humane kill. For example in FIG. 22 this orients the head region 56 in the optimal location for the hammer 25 to make the most humane kill.

Regardless of the orientation it may be necessary to affix the apparatus 18 to the mounting surface 45, particularly for example when the mounting surface is oriented other than vertical. This also prevents unwanted removal by other users, pests, or natural phenomena, eg rain, water, wind, vandals or other interference etc. There are several methods that may be used, the preferred is a fastener 52 through mounting holes 53 as shown in FIG. 12, into the mounting surface 45. Alternative forms may also be used such as ties that pass around the mounting surface, for example a tree, and through the, or a, mounting hole in the apparatus to retain the apparatus thereto.

In other forms the apparatus may be in an shroud, surround or enclosure 64 as shown in FIG. 19. The weight and size of the trap may also be a deterrent to its unwanted movement.

The species adapter 33 may also be of a different size and shape depending on the target pest species.

Mounted from the trap enclosure 19 is the actuation system or kill engine 9. The functioning of this is described below. The kill engine 9 actuates a striking rod, and connected to the end of the striking rod is a force deli ₄₆ hammer 25. It is the force delivery hammer 25 that is driven across the kill zone 34 by the kill engine 9 to deliver the incapacitating energy, at least in part, to the target pest species 20.

Attached to the trap enclosure 19, or part thereof, or the species adapter 33 is a bait catchment 6 or bait station 6. As the name suggests this is to lure the pest into the interior 28 and into the kill zone 34. The bait may be in any form that will attract the pest. In one form, as shown the bait may be of foam eggs preferably the size of a bird egg the target pest species preys on; wherein the foam eggs contain a scent of real (actual) bird eggs. The bait is contained within a bait catchment 6, which in the embodiment shown has a mesh frame on the sides facing the rodent. The apparatus 18 provides a line of sight 29 through the apparatus 18 so that the rodent is able to see through the bait mesh towards the foam eggs, and through the other side. This is proven as a more effective way of enticing the target pest species into the interior 28. The bait catchment 6 is detachable so as to be removable wherein the bait 4 can be placed within the platform of the strike zone 3, but preferably it is contained within the bait catchment 6.

Once the rodent has travelled up the ramp 1, it will enter the strike zone 3. The strike zone 3 is a suitably contoured region for the specific target species. In that shown in FIG. 4 for example this is a is a horizontal flat zone (shown more clearly in FIG. 12) enclosed on both sides where one side consists of the striking rod 5 which will on actuation of a sensor or trigger 31, strike laterally of the target pest species with the force delivery hammer 25. On a side opposing this there is optionally a force delivery portion 32. In the form shown this is a latchable door 7 which is latched or held by some force which can be overcome by the kill engine, eg a magnet, when the pest is in the strike zone 3 and is struck by the hammer 25 thus sending the pest 20 into, onto or toward the portion 32 to impact therewith. In some forms the portion 32 may impart further energy into the pest 20 aiding in its humane dispatch. In other forms or as well, for example when acting as a door 7 it acts to exclude entry to the strike zone 3 and kill zone 34, requiring the pest to enter only from the entry point or region 27. In so doing, this also prevents non-target species, for example desirable native species, from accessing the strike zone 3 and kill zone 34.

Within a certain delay time frame or energy delay the door 7 will open. The remaining energy will then expel the incapacitated pest 20 through the exit aperture 41, which in this case, the opening of the door has exposed. The time delay may be via a latch which becomes unlatched, or the energy delay may be for example, but not limited to a magnet, holding the door closed. When the energy level against the door, from the force delivery hammer 25 striking the pest, and in turn the pest striking the door 7, this retention force of the latch, or magnet is overcome and the door opens. In doing so, as described, this may impart further kill energy into the pest, or the pest may be dispatched before it impacts the door or other structures.

In the preferred arrangement shown the plane of the exit aperture is substantially perpendicular to the lateral motion of the force delivery hammer 25, 5. The line of sight in turn is in the same plane, or parallel thereto, as the lateral motion of the force delivery hammer 25, but substantially perpendicular thereto, as shown in FIG. 4.

In a preferred embodiment the force of the striker hammer 25, transmitted through the pest opens the door 7 via action on the animal, ie there is no direct action on the door by the striker. Therefore in this arrangement the door is opened after the contact is made between the striker and animal. In an alternative arrangement the striker releases a latch at a certain extension of the striker or delay after a certain extension or triggering.

It should be noted the delay in the door 7 in this case, opening is not to statically dispose of the pest, but rather to act dynamically to apply further incapacitating energy to the pest as well as then expel the incapacitated pest. The delay in the door opening also may be caused by the above described ways in which the door is kept shut until impacted by the pest, even if the pest is already rendered irreversibly unconscious and no further energy is required to achieve that state. For example the incapacitated, or near so, pest has to overcome the force that is holding the door 7 closed, and this in turn may create a delay in it opening.

In other forms, shown in FIG. 10, there is no door, but rather part of the trap enclosure or species adapter may optionally act, if necessary as the force delivery portion to further impact the in motion pest as seen in FIG. 20. In this case the force delivery hammer delivers the primary energy, and accelerates the pest, and the force delivery portion 32 delivers secondary energy, decelerating the pest, prior to it being expelled from the exit aperture.

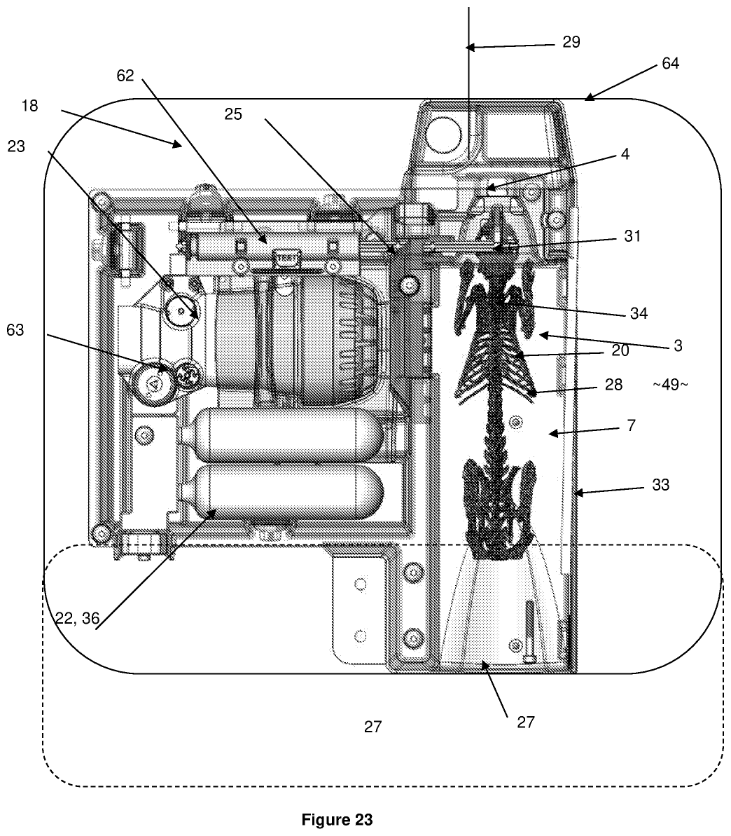

In use a pest will enter the apparatus 18 via the species adapter 33, for example as shown via the ramp 1 (FIG. 13). The pest is attracted or lured to the apparatus 18, either because of its own curiosity, or by the smell of the bait, or a combination thereof. The pest 20 proceeds along the species adapter 33 and past the entry point 27 to the trap interior 28 and moves towards the bait catchment or station 6. The pest 20 has a line of sight 29 through the trap which entices, or at least does not detract from, its natural desire to explore further and reach the bait. The pest then moves into the strike zone 3. Once sufficiently far into the trap the pest 20 will connect with or otherwise activate the trigger mechanism 31. This connection maybe with a portion of their body, for example the top of their head forcing the trigger mechanism in the act of trying to access the bait, for example as shown in FIGS. 23 to 25. However, in other forms the pest 20 may activate the trigger mechanism 31 in other ways, for example as shown in FIG. 26 whereby the pest 20, in this case a possum, chews, pulls or pushes on or otherwise disturbs a bite portion 67 of the trigger mechanism 31 with their mouth, thus activating the trap.

The trigger mechanism may also interplay with the guide portions and surfaces. For example the width of bite portion may be wider than the jaw of the pest 20 so they can open so can only approach the trigger in one way to bite it. Thus again ensuring the correct orientation for a human kill.

The trigger mechanism in the example in FIG. 26 again is a pivot mechanism and pivots about pivot 68 to then trigger the kill engine 23.

This will then activate the kill engine to drive the force delivery hammer laterally across the kill zone 34, for example in FIGS. 4 to 21, or from above the pest's head down into the kill zone 34 as shown in FIG. 26, to deliver the incapacitating energy to the pest 20. The energy imparted by the hammer 25 to the pest 20 then sends the pest 20 towards the exit aperture 41, when the hammer 25 stroke is horizontal. Alternatively the pest 20 may exit the trap 18 under gravity alone as in that shown in FIG. 26, or in combination with the movement of the hammer 25, as shown in FIG. 4. At this point or shortly thereafter, if there is a further energy delivery or deceleration point, such as the latch door 7, or force delivery portion 32, the pest 20 has expired, or will expire. The pest then continues due to the imparted energy, gravity or both, out the exit aperture, whether to engage further force delivery portions 32 or not, and is expelled from the apparatus 18.

In terms of humane kills the term irreversible unconsciousness is used to describe a state of the pest where it is at a point where it cannot be returned to consciousness and is cannot sense pain. The quicker the time from alive to a state of irreversible unconsciousness the more humane a kill method is.

The process from triggering by the pest to expulsion occurs in under 1 second, and in the preferred form occurs within 0.001 seconds to 0.2 seconds, and ideally within 0.002 seconds. This means that from triggering by the pest, to incapacitation by irreversible unconsciousness is less 0.1 seconds. This short time frame is a very humane way to cull the pest.

The trigger mechanism 31 may take a number of forms. In the preferred form there is a mechanical activation within or near the strike zone to then activate the kill engine 23. In other less preferred forms there may be a light beam, hall sensor, or similar non-contact trigger.

The mechanical activation of the trigger mechanism 31 may be a whisker, or brush or step plate or similar the pest 20 engages with en route toward the bait. This then activates one or more valves to fire the kill engine 23. The primary or first, or only valve, that is actuated is a low force valve, or a highly leveraged valve, to reduce, or overcome any stiction or similar in the valve train for activating the kill engine 23. The trigger valve could be one of a number of types of valve, for example a needle, tilt, or other type of “seal breaker” valve, that is a valve which intrinsically has high mechanical advantage needed to break a seal.

In one preferred form being the trigger mechanism 31 opens a primary valve 15, to produce an air pressure difference across the trigger hammer 50 to then drive the trigger hammer to actuate a dose valve (explained below).

The trigger hammer 50 is held in a rearward position by differential pressure and in some embodiments spring force. When the trigger mechanism 31 is activated this is turn actuates the valve 15 to evacuate a cavity in front of the hammer, establishing a pressure bias across the hammer 50. The trapped higher pressurised gas, pushes against the hammer 50, moving it, and thereby expanding and driving it to hit the dose valve 51 preferably against a return bias. Once the hammer 50 is in contact with the main flow control valve or dose valve 51, it is enough to open the dose valve 51 by overcoming the differential pressure force and spring force which normally holds that valve 51 closed and sealed.

The hammer 50, continuing to open the dose valve 51 further, moves sufficiently to exhaust the air behind it which has provided the impetus to move the hammer 50 forward and act on the dose valve 51. This then allows the hammer 50 to return to return under spring and/or differential pressure forces generated by a pressure supply (throttled or otherwise) to return to its rearward starting, pre-triggered position. This also then allows the dose valve 51 to return under spring and/or differential pressure forces to return to its closed position separating the dose chamber 11 from the working chamber 38.

The bias, for example a spring acting on the hammer 50 will push the hammer 50 back to or towards the starting, pre-triggered position at which

1. the Dose valve 51 can close and is no longer open, and

2. there is no exhaust path from the hammer chamber to atmosphere. The bias may or may not push the hammer 50 back completely to its starting position, and it may use additional air pressure from the piston returning back up the working chamber 38 to drive it to its pre-triggered, starting position.

The kill engine 9 or 23 has three main components, a trigger hammer 50, dose chamber 11, and working chamber 38. The working chamber 38 contains a piston 37 and piston rod or striking rod 5, the piston 37 and piston or striking rod 5 can translate along the chamber. The dose chamber when the trap is armed receives a charge of high pressure air from the reservoir 22 and holds it there until needed. A dose valve 51 sits between the dose chamber 11 and the working chamber 38 and is normally biased closed to seal the dose chamber 11 (and its charge of high pressure air) from the working chamber 38. When the trigger mechanism 31 in the trap is activated it triggers the trigger hammer 50, as described above for example, to rapidly move and strike the top of the dose valve 51 in the centre, driving it open. The high pressure air in the dose chamber 11 rushes into the working chamber 38 and in part holds the dose valve 51 open. The rush of high pressure air in drives the piston 37 down (along) the working chamber 38, extending the striking rod 5. On the end of the striking rod is the force delivery hammer 25. This then strikes the pest delivering an incapacitating energy.

In trials to date this renders the pest irreversibly unconscious near instantaneously via a combination of severe brain trauma, and/or stopping the heart and severing the spinal column. The pest is expelled, optionally at least in part by the incapacitating energy, out an exit aperture 41 of the trap enclosure. The exit aperture 41, whether formed by a door opening, or otherwise, in the preferred form is in a plane perpendicular to the line of action of the striking rod, and for example may be on the side of the enclosure in the direction the force delivery hammer moves when extending and striking the pest. In other forms, for example as shown in FIG. 26, the exit aperture 41, is also the entry point 27 as the pest falls out the bottom of the trap 18, which is mounted on a vertical, or similar surface, under the action of gravity.

Once the incapacitating energy is delivered the piston, from an air cushion on its back side within the working chamber 38, is sent back up to the start position in the working chamber, also retracting the striking rod 5 and force delivery hammer 25. Meanwhile, due to the low pressure now between the piston and dose chamber, as the charge of air has done its work, the dose valve 51 closes and the dose chamber 11 is charged again.

Closing of the dose valve in part pushes the trigger hammer 50 back, either in part and in combination with a bias, or in total, and relocks it in the starting, pre-triggered ready to fire position and opens an exhaust path to atmosphere. Thus as the piston 37 travels back up the working chamber there is little air resistance in front of it as it is pushing the air out.

The trap is now ready to fire again should a pest enter it.

The proposed pest trap 18, and its method of operation is shown generally in FIGS. 4 to 27, and more specifically in cross section image in FIGS. 18 and 19, will include a trap enclosure 7 containing, at least in part a bait station 4 to lure the pest 20 into the trap enclosure interior 28. The trap enclosure will also contain the trigger mechanism 31. The trigger mechanism 31 is activated by the pest 20. The trigger mechanism 31 in turn will trigger the kill engine 9 mounted from the trap enclosure. The kill engine will drive a force delivery hammer 25) in a lateral way across a part of the trap enclosure interior, in an area defined as the strike zone 3, and more accurately the kill zone 34 The kill engine 23 is non-flammable gas supplied from a reservoir 22 of high pressure air (4000 psi or more) connected to the kill engine. For example the non-flammable gas may be compressed air, compressed carbon dioxide or similar gas. The non-flammable gas may be contained in easily replaceable cartridges 36, for example as shown in FIG. 23.

The resultant pest trap 18 is portable and the reservoir 22 can be refilled or replaced as needed. One way is to simply replace the cartridges 36, of which they may be more than one. Alternatively the supply 22 may be re-pressurised by a pump or compressor connectable to the supply 22. The kill engine is very similar in operation to that described in our patent EP 2367660.

The trap 18 shown in FIG. 23 may be located within a further enclosure such as a surround or shroud 64, as shown in FIG. 23 for example. Such a shroud or enclosure 64 is desirable when the trap 18 is located in a public space and any form of interference, whether human, animal or otherwise is preferred to be avoided. A body region 49 may also be present within the enclosure for holding one or more bodies of dispatched pests. This may be useful in preventing smell, or other pests accessing and hastening decay, of the dispatched pest. The latchable door 7 may separate the body region 49 from the trap interior 29 and provide a substantially sealed region. This is useful when it is considered that the trap interior 29 may be open to the environment, so the door 7 prevents access of other pests, for example flies, to the bodies, and prevents escape of smell or liquids. This may be desirable when the trap is in a commercial setting and a dead animal that is smelling or attracting other pests may be undesirable, for example in, public, food handling or storage areas. This may also be desirable when the trap 18 is only serviced periodically and so therefore may have dispatched more than one pest 20. The body region may be beside and extend underneath the trap, and may have a plastic bag arrangement or similar for the bodies to be ejected into, so that removal of the bodies is easily facilitated, the trap is kept cleaner, and a sealed region in conjunction with the door can be provided.

The enclosure may fully or partially enclose the trap 18 and effectively is part of the trap, as from the outside it is the only evident aspect. The enclosure 64 may be a simple surround of vertical walls, may include a base, and may include a top. In the preferred form the enclosure is a base and walls to surround the trap 18. A cover then engages to fully enclose the trap. The cover may engage with the trap and or the walls of the enclosure to retain it there to. Such retention may be tamper proof and may use a lock or other such similar system.

The enclosure 64 may also form part of a safety system for the trap, preventing the trap from actuating unless the enclosure is fully assembled correctly. For example the lid when connected properly may enable the trigger mechanism 31, such that the trap will not actuate to kill a pest without the enclosure fully and correctly in place. This can be for safety of the user, animals (target and non-target alike), as the forces involved when the trap actuates are high and may maim or injure a human or animal. The enclosure 64 also therefore may form part of the trap enclosure 19, and also act as part of the species adapter 33, as the enclosure 64 may be attached or part of the enclosure 19, and will act to exclude non-target species, by preventing their access, and so functions as part of the species adapter 33.

The enclosure 64 will also provide access to the entry point 27 of the trap 18. Such access may be an opening directly onto the entry point 27, such as shown in FIG. 23, or optionally there may be a tunnel, pathway 65 (shown in dashed line in FIG. 23) or similar the enclosure 64 at least in part provides to the entry point 27. Such will dependent on the target pest species 20. For example rats while curious will typically only run along a wall, thus a through tunnel perpendicular to the entry point 27 may be provided, whilst also allowing the rat to turn off the tunnel to enter the trap.

The trap 18 may also have the ability to test fire it, for example by providing a test actuator 62. This may actuate the trap 18 in a number of ways. For example the test actuator 62 may act on the trigger mechanism 31 by moving it in a way similar to what the pest 20 would, thus firing the trap. In other forms it may act on the pneumatics of the kill engine 23, but dumping a valve chamber or similar, to actuate the trap 18. In this way a user can confirm the trap is working correctly.

The trap 18 also may have a safety actuator 63 to provide the ability to make it safe. This is to prevent the trap 18 from actuating when it is being stored, transported, maintained or similar. Such safety actuator may purge any one or more of the valve chambers of the kill engine 23, for example the dose chamber 11, of the operating gas, such that even if the trigger mechanism 31 is actuated the kill engine 23 cannot fire. This is desirable at least from a safety standpoint.

The trap 18 of the present invention is also preferred to be modular, such that the one kill engine can interface with a number of different hammers 25, species adapters 33, and if necessary enclosures or shrouds 64 to provide a modular pest control system. This allows a trap 18 to be assembled from a common array of parts for the target species 20.

The foregoing description of the invention includes preferred forms thereof. Modifications may be made thereto without departing from the scope of the invention.

1. A method of incapacitating a target pest species comprising or including the steps of:
Providing a trap enclosure, the trap enclosure having an entry point for the target pest species into an interior of the trap enclosure, and a bait station to attract the target pest species,
providing a kill engine, at least in part mounted from the trap enclosure, to at least in part deliver incapacitating energy to the target species, whereby the kill engine does not require electricity, the kill engine using an inflammable gas charge, the kill engine when triggered actuates and then resets itself,
providing a source of compressed inflammable gas, connected to, and supplying the kill engine,
having a species adapter connected at least in part to the trap enclosure to adapt the trap enclosure to the target pest species, the species adapter based on the size, habits or travel, nature of the target pest species,
defining a kill zone within an interior of the trap enclosure and or the species adapter,
providing a trigger mechanism to actuate the kill engine when triggered by the target pest species when in the kill zone,
providing a force delivery hammer, driven by the kill engine, to deliver the incapacitating energy,
such that when the target pest species enters the apparatus and the kill zone it triggers the trigger mechanism to in turn actuate the kill engine to deliver the incapacitating energy by impacting the pest.

2. A method as claimed in claim 1 the trap enclosure includes, at least in part, an exit aperture from the interior to the exterior, such that the incapacitated target pest species can be ejected from the interior to the exterior.

3. A method as claimed in claim 2 which includes providing the exit aperture substantially parallel to the translational force, such that the incapacitating energy expels the pest from the trap interior to a trap exterior.

4. A method as claimed in any one of claims 1 to 3 wherein the translational force alone is sufficient to incapacitate the target pest species.

5. A method as claimed in any one of claims 1 to 4 wherein the inflammable gas is any one or more of air, carbon dioxide or similar.

6. A method as claimed in claim 5 wherein the force released by the trigger is caused by, any one or more of,
a. a pressure bias acting on an area or multiple areas of the delivery hammer,
b. the removal of a restraint that stops movement of a compressed elastic member,
c. a gas spring,
d. an electromagnetic effect, and
e. an impact from another moving component on the delivery hammer.

7. A method as claimed in any one of claims 1 to 6 wherein the impact of the hammer alone is sufficient to incapacitate the target pest species.

8. A method as claimed in any one of claims 1 to 7 wherein the pest additionally impacts other force delivery portions after impact by the hammer, to delivery sufficient energy to incapacitate the target pest species.

9. A method as claimed in claim 8 wherein the trap enclosure or species adapter has the force delivery portion(s), whether static or mobile as a result of the incapacitating energy, that aid in delivering the incapacitating energy.

10. A method as claimed in either of claim 8 or 9 wherein the force delivery portion(s) act from the opposing side the force delivery hammer acts from.

11. A method as claimed in claim 10 wherein the force delivery portion at least in part obscures the exit aperture.

12. A method as claimed in either of claim 10 or 11 wherein the force delivery portion includes a latchable door that co-operates with the force delivery hammer in ejecting the pest from trap and/or delivering the incapacitating energy by initially resisting the force delivery hammer.

13. A method as claimed in claim 12 wherein the force delivery hammer delivers a primary incapacitating energy and the force delivery portion co-operates to deliver a secondary incapacitating energy, one or more or both together sufficient to incapacitate the target pest species.

14. A method as claimed in any either of claim 12 or 13 wherein the latchable door at least in part further obscures the exit aperture.

15. A method as claimed in any one of claims 12 to 14 wherein the latchable door is on a time or energy delay to increase the energy delivery to the target pest species.

16. A method as claimed in claim 15 wherein after the time or energy delay the latchable door opens to expel the target pest species via the exit aperture.

17. A method as claimed in any one of claims 12 to 16 wherein the latchable door opens in a direction parallel to the motion of the force delivery hammer.

18. A method as claimed in any one of claims 12 to 17 wherein the latchable door is pivoted on an axis above the kill zone such that when it opens it swings out of the way, the energy imparted to the target pest species then expels it from the kill zone.

19. A method as claimed in any one of claims 13 to 18 wherein the latchable door uses a magnet, mechanical latch, timing or similar mechanism that is overcome by the energy to then release the door, or that releases the door a certain period of time after triggering of the kill engine, or movement of the force delivery hammer.

20. A method as claimed in any one of claims 12 to 19 wherein the latchable door is biased to return to the closed latched state by gravity or a biasing mechanism.

21. A method as claimed in any one of claims 1 to 20 wherein the exit aperture is in a plane substantially perpendicular to the linear action of the force delivery hammer.

22. A method as claimed in any one of claims 1 to 21 wherein the entry point is in a plane substantially parallel to the linear action of the force delivery hammer.

23. A method as claimed in any one of claims 1 to 22 wherein the force delivery hammer impacts the target pest species at a first location, and then, after the first location, at a second location, wherein the first location is the skull region and the second location is the body region.

24. A method as claimed in any one of claims 8 to 23 wherein the force delivery portion is a fixed portion of the trap enclosure which the target pest species will be forced against by the force delivery hammer, to deliver further energy to the target pest species.

25. A method as claimed in any one of claims 1 to 24 wherein the exit aperture can serve as an entry point for the target pest species.

26. A method as claimed in any one of claims 1 to 26 wherein the kill engine can be removed from the trap enclosure should it need repair, maintenance or replacement, and the trap enclosure can be left in place.

27. A method as claimed in any one of claims 1 to 26 wherein the species adapter includes a guide portion to the entry point.

28. A method as claimed in claim 26 wherein the guide portion is a guide surface or surfaces for the target pest species, or part thereof, to move along from the mounting surface to the entry point.

29. A method as claimed in any one of claims 1 to 28 wherein the species adapter at least in part defines the entry point.

30. A method as claimed in any one of claims 1 to 29 wherein the species adapter at least in part defines the exit aperture.

31. A method as claimed in any one of claims 1 to 30 wherein the incapacitating energy is sufficient to do to the target pest species any one or more of,
stop the heart,
dislocate the neck and,
disrupt brain matter, or
sever the spinal column,
sufficient to render the pest irreversibly unconscious.

32. A method as claimed in any one of claims 1 to 31 wherein the target pest species is rendered irreversibly unconscious and expelled within a time frame of under 1 second.

33. A method as claimed in any one of claims 1 to 32 wherein the target pest species is rendered incapacitated and expelled within a time of 0.050 seconds to 0.2 seconds and preferably within 0.02 seconds.

34. A method as claimed in any one of claims 1 to 33 wherein the force delivery hammer connects with either the body portion or head portion of the target pest species.

35. A method as claimed in claim 34 wherein the force delivery hammer impacts the target pest species at a first location, and then, after the first location, at a second location.

36. A method as claimed in claim 34 wherein the first location is the head portion and the second location is the body portion.

37. A method as claimed in any one of claims 1 to 36 wherein the force delivery hammer is contoured to reduce the area of delivery to the target pest species, to increase the impact stress/energy delivered to effect a humane kill.

38. A method as claimed in any one of claims 1 to 37 wherein there is a restraining portion to restrain at least in part, the body portion, or head portion, when the force delivery hammer connects with the head portion, or body portion.

39. A method as claimed in claim 38 wherein the restraining is dynamic.

40. A method as claimed in any one of claims 1 to 39 wherein the incapacitating energy, and or gravity is at least in part sufficient to expel the target pest species from the trap interior to the trap exterior.

41. A method as claimed in any one of claims 1 to 40 wherein the trap is substantially vertically mounted, and entry into and exit out of the trap of the pest is in a vertical direction.

42. A method as claimed in claim 41 wherein the pest is a possum or similarly vertically moving pest.

43. A method as claimed in any one of claims 1 to 42 wherein the trap is substantially horizontally mounted, and entry into, and exit out of the trap is in a horizontal direction.

44. A method as claimed in claim 43 wherein the pest is a mouse, rat, stoat, ferret or similar animal.

45. A method as claimed in any one of claims 1 to 44 wherein the pest control apparatus includes a fluidly connected refillable gas reservoir to hold a store of gas for the gas charge.

46. A method as claimed in any one of claims 1 to 45 wherein the gas is stored in the refillable reservoir at a pressure between 600 pounds per square inch and 6000 pounds per square inch.

47. A method as claimed in any one of claims 1 to 46 wherein the gas is regulated to operate the piston at between 125 pounds per square inch and 600 pounds per square inch.

48. A method as claimed in any one of claims 1 to 47 the gas is stored at 800 pounds per square inch.

49. A method as claimed in any one of claims 1 to 48 wherein the gas is regulated to operate the piston at 175 pounds per square inch.

50. A method as claimed in any one of claims 1 to 49 wherein the refillable reservoir remains connected when being refilled.

51. A method as claimed in any one of claims 1 to 50 wherein a specific target species apparatus can be assembled from the kill engine, trap enclosure and specific target species adapter.

52. A method as claimed in any one of claims 1 to 51 wherein the trigger mechanism is activated by a body part of the pest, such as the head, body or feet, or may be operated when the pest bites a portion of the trigger mechanism.

53. A method as claimed in any one of claims 1 to 52 wherein the entry point has a line of sight from the entry, through the trap enclosure, to exterior of the trap enclosure.

54. A method as claimed in claim 53 wherein the linear action of the force delivery hammer is substantially perpendicular to the line of sight.

55. A method of operating a self re-setting trap to incapacitate a target pest species comprising or including the steps of:
Luring a target pest species into a trap enclosure, the trap enclosure with a species adapter excluding non-target pest species from entering, the target pest species entering a kill zone defined by the trap enclosure and or species adapter,
The target pest species triggering a trigger mechanism when in the kill zone, which in turn actuates a kill engine, the kill engine, at least in part mounted from the trap enclosure, to at least in part deliver incapacitating energy to the target species, whereby the kill engine does not require electricity, the kill engine using an inflammable gas charge, the kill engine when triggered actuates and then resets itself,
Driving a force delivery hammer across the kill zone to deliver the incapacitating energy,
Expelling the target pest species from the trap by the incapacitating energy and or gravity.

56. A self-resetting pest control apparatus to incapacitate a target pest species and reset itself after such incapacitation, comprising or including,
A kill engine to at least in part deliver incapacitating energy to the target species, whereby the kill engine does not require electricity, the kill engine using an inflammable gas charge, the kill engine when triggered, will actuate and then reset itself,
a source of compressed inflammable gas, connected to and supplying the kill engine,
a force delivery hammer, driven by the kill engine, that when actuated linearly delivers the incapacitating energy to the target pest species by impacting thereon,
A trap enclosure from which the kill engine is at least in part mounted, the trap enclosure having an entry point for the target pest species into an interior of the trap
enclosure, a bait station, and trigger mechanism to trigger the kill engine, and,
A species adapter to connect at least in part to the trap enclosure to adapt the trap enclosure to the target pest species, the species adapter based on the size, habits or travel
nature of the target pest species,
such that when a target pest species enters the apparatus it triggers the trigger mechanism, causing the kill engine to actuate and deliver incapacitating energy to the target pest species.

57. A trap as claimed in claim 56 wherein the exit aperture is in a plane substantially perpendicular to the linear action of the force delivery hammer.

58. A trap as claimed in either of claim 56 or 57 wherein the entry point is in a plane substantially parallel to the linear action of the force delivery hammer.

59. A trap as claimed in any one of claims 56 to 58 wherein the linear action of the force delivery hammer is substantially perpendicular to the line of sight.

60. A method of incapacitating a target pest species as described herein with reference to any one or more of the accompanying drawings.

61. A method of operating a trap to incapacitate a target pest species as described herein with reference to any one or more of the accompanying drawings.

62. A pest control trap to incapacitate a target pest species as described herein with reference to any one or more of the accompanying drawings.
